(19) United States
(12) Patent Application Publication
(10) Pub. No.: US 2003/0195790 A1
(43) Pub. Date: Oct. 16, 2003

(54) Electronic system for equipment repair orders

(76) Inventors: John Wepfer, Orland Park, IL (US); Cindy Lawbaugh, Monee, IL (US); James Roberts, Algonquin, IL (US)

Correspondence Address: Steven G. Steger, Mayer, Brown, Rowe & Maw, P.O. Box 2828, Chicago, IL, 60690-2828, US

(21) Appl. No.: 10/123,836

(22) Filed: Apr. 16, 2002

(51) Int. Cl. G06F 17/60

(52) U.S. Cl. 705/9

(57) ABSTRACT

A computer network is disclosed that is used to manage the activities of a network of service technicians and to coordinate intermodal transportation equipment repair service orders and subsequent invoices to customers. In this computer network, service and repair data is gathered, service orders are assigned, information about work performed by service technicians is entered, customer signatures are captured, and data is generated and exported to a server computer, and subsequently to a central computer wherein it can be combined with other data and used for a number of purposes.

### BACKGROUND

1. Field of the Invention

The present invention relates generally to a system for managing repair orders for equipment repair and, more specifically, to a networked computing system for managing orders for repair of intermodal transportation equipment such as trailers, containers and chassis.

2. Description of Related Art

The repair of equipment, such as trailers, containers, chassis and other intermodal transportation equipment, is often conducted by a network of service technicians. In the past, such a network of service technicians has been controlled and monitored through the use of paper service orders to assign and monitor repair tasks. When repair of equipment was needed, the work was assigned to a specific technician. After the work was performed, the technician was required to prepare written report describing the work performed, date and time of work, part numbers used, and any issues or questions regarding work performed.

An invoice charging for the work performed was then prepared and forwarded to the customer. This type of paper system of documentation to monitor and control repair activity generates a large volume of paperwork that must be managed and stored, as well as physically transported from the technician in the field to a central location.

The above described type of system incorporating paper work orders, written work reports, and paper invoices, and the subsequent large volume of paperwork, results in a number of problems. For example, the large volume of paper documents requires substantial physical storage space, increases costs related to data entry clerks spending time keying manually written service orders and work reports and the subsequent time spent correcting errors in the data entry, significantly delays gathering information from technicians resulting from the required physical transportation of the documents, incomplete entry of information on written reports due to the inconvenience of handwriting the information, and delays in inventory control related to parts and/or components used by the technician that are not automatically input into an inventory control system.

Furthermore, the delay in transfer of physical documents creates a greater length of time between the performance of work and the review of the documents, making it more difficult to obtain accurate answers to any questions that arise regarding the work performed. Also, the delay of transfer of physical documents creates a negative impact on the cash flow of the repair business because the time between the actual repair service and the final processing of the information delays the creation and sending of invoices. Compounding this problem, some customers require invoicing of repairs within a certain amount of time after the work has been completed. If this time is exceeded, collection on the invoice can become difficult.

Therefore, there is a need for a system to manage orders for intermodal transportation equipment repair in which the volume of paper documents to be completed and transferred is reduced, data accuracy is increased, and the transfer of information occurs in a faster and more efficient fashion.

### SUMMARY

The purpose and advantages of the invention will be set forth in, and apparent from, the description and drawings that follow, as well as will be learned through practice of the invention. Additional advantages of the invention will be realized and attained by the elements of the physical embodiment of the invention and methods of using the invention described herein.

In accordance with one aspect of the present invention, a computer network is used to manage the activities of a network of service technicians and to coordinate intermodal transportation equipment repair service orders and subsequent invoices to customers. In this computer network, service and repair data is gathered, service orders are assigned, information about work performed by service technicians is entered, and data is generated and exported to a server computer wherein it can be combined with other data and used for a number of purposes. In addition, the server computer communicates, either alone or in combination with a number of other server computers, with a central computer. The central computer performs functions that complement, the server computers, and subsequently the mobile units, such as maintaining master table data, inventory, customer billing and network control.

Orders for repair work are input into the repair system, including a description of the customer requesting work, the work desired, the location, and the repair hours. The repair system then may assign the service order to a service technician. This assignment can be done either manually or through a computerized assignment system. In the alternative, where the user is the technician to perform the work, he may simply perform the repair order, rather than assigning it to another service technician.

When the work order has been assigned to a service technician, the technician performs the work as has been done in the past. Rather than prepare a handwritten summary of the work, however, the service technician inputs information into the repair network through a work station, such as a mobile unit. This work station can be mobile, such as a pen-based, hand-held computer, a notebook computer, or any other portable computer, or the work station can be stationary, such as a desktop personal computer, or any other type of input device suitable to transmit information to the repair network.

The technician is prompted to enter information such as work performed, parts used, service details via job matrix codes, date and time of repair, intermodal transportation equipment identification, length of time worked on project, or any other information that is desirable to be captured about service work for equipment. Various screens are accessed by the technician by clicking tabs on the screen of the mobile unit. These various screens provide and gather information as described further below.

In a preferred embodiment, the description of the repair work is captured through a series of codes that are defined specifically to the type of equipment being repaired. The technician is able to simply select the codes that describe the repair performed through a series of choices. The system virtually eliminates the need for the technician to handwrite a lengthy recap of all of the work performed. Such handwritten paragraphs are time-consuming to prepare and difficult to retrieve for later analysis. The system also provides the server and/or central computer with concise information that can be used by service and product support personnel for analyzing future equipment failures. The work done can be stored in a number of different formats such as by task, by technician, or by equipment ID. This information is then available to generate various reports and to search using query functions.

After the technician has finished entering the information into the mobile unit, the unit communicates with the server computer in a manner known in the art (i.e., cellular network connection, radio frequency connection, global computer network connection, or connection through a local area network) to transmit the information to the server computer. The server computer then communicates with the central computer to further transmit the information to larger databases in the central computer. In the preferred embodiment, the information is passed from the mobile units, and then on to the server computer, and eventually through a file transfer protocol (ftp) system to the central computer. However, the connection between the mobile units and the server computer, and between the server computer and the central computer, can also be direct connections. After the information from the individual technicians is transferred to the server computer and/or central computer, the information can be used for a variety of applications. Some examples include customer billing, inventory control, cost reporting, vendor processing and accounts payable, payroll and labor distribution.

Thus, the present inventions allows repair order requirements to be directed by customers through definitions in the administrative software, greatly reducing the need for technicians to interpret the requirements of the customers. In addition, fields of information are table-driven, and choices are limited to those valid for a given type of repair. For example, a repair order on a chassis only allows Job Codes valid for chassis repairs. Additionally, Why Made, Condition and Location codes limited to those valid with the Job Code selected. This results in more accurate, consistent order data.

Data is stored historically by repair unit for a user-defined period of time, limited only by the storage capacity of the computer's hard drive. Information is used as a inquiry tool by administrative personnel, this information is also accessible to view during entry of a new repair orders, to avoid duplicate repairs.

Orders pass through various stages—beginning with Grading (optional), becoming an Estimate (when required), Pending (approved for work), Work in Process, Work Completed, and ultimately approved by a manager. The repair software tracks each status of the order, and provides listings of all orders at each phase. This enables users, depending on their function, to view orders that are their responsibility, and also provides managers a database with which to monitor repair order activity for the entire operation.

Parts and inventory tracking is comprised of three elements: “Parts” where parts numbers are established; “Parts List” identifies which Job Codes the parts are used on (repair order entry will then invoke this list of parts when the Job Code is entered); and “Inventory” where on-hand balance is kept, and quantity transactions are recorded and viewed.

These and other features and advantages of the invention will be apparent upon consideration of the following detailed description of the presently preferred embodiments of the invention, taken in conjunction with the claims and appended drawings, as well as will be learned through the practice of the invention.

### BRIEF DESCRIPTION OF THE DRAWINGS

FIG. 1 is a block diagram of an electronic system for intermodal transportation equipment repair orders in accordance with an embodiment of the present invention;

FIGS. 2-6 are logic flow diagrams of the repair data entry functions of an electronic system for intermodal transportation equipment repair orders in accordance with an embodiment of the present invention;

FIGS. 7-26 are illustrations of various screens on a mobile unit of an electronic system for intermodal transportation equipment repair orders in accordance with an embodiment of the present invention;

FIGS. 27-33 are logic flow diagrams of the administrative data entry functions of an electronic system for intermodal transportation equipment repair orders in accordance with an embodiment of the present invention; and

FIGS. 34-84 are illustrations of various screens on a central computer for the administrative functions of an electronic system for intermodal transportation equipment repair orders in accordance with an embodiment of the present invention;

### DESCRIPTION OF THE PREFERRED EMBODIMENTS

While the invention can be embodied in many different forms, there is shown in the drawings, and will herein be described in detail, a preferred embodiment of the present invention with the understanding that the present disclosure is to be considered as an exemplification of the principles of the invention and is not intended to limit the invention to the embodiments illustrated.

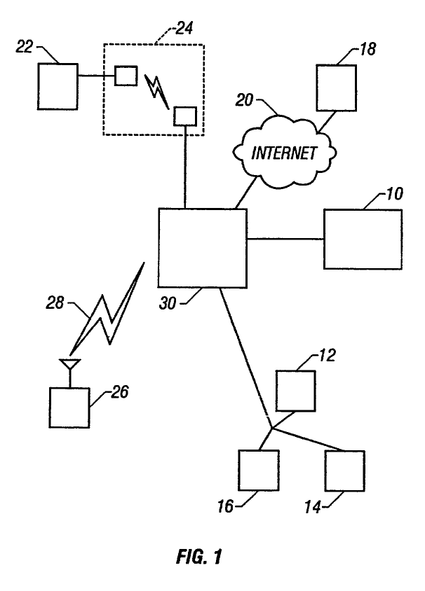

Referring now to FIG. 1, a block diagram an electronic system for intermodal transportation equipment repair orders in accordance with an embodiment of the present invention is shown. The system comprises a central computer 10 on which information is stored and to and from which information is transferred throughout the system to various server computers 30. The central computer 10 and server computers 30 are preferably personal computers, however, any type of computer with sufficient memory and processing power can be used. Please note that, for ease of illustration, a single server computer 30 is shown, however, the invention contemplates using one or multiple such server computers 30 networked together through the central computer 10. The server computer 30 can be connected to the central computer 10 via a local area network (LAN); via the global computer network, also known as the Internet; via remote communication through the airwaves (e.g. CDMA, GSM, GPRS or a cellular connection through the global computer network (CDPD)); via a radio frequency (RF) link; or by any other communication link suitable for transferring digital data.

Also shown in FIG. 1 are a number of mobile units connected to the server computer 30 in a number of different ways. The connection of the mobile units to the server computer 30 can include, for example: computers 12, 14 and 16 that are connected to server computer 30 directly via a LAN; computer 18 that is connected to server computer 30 via the Internet 20; computer 22 that is connected to server computer 30 via remote communication through the airwaves (e.g. CDMA, GSM, GPRS or a cellular connection through the global computer network (CDPD)) generally designated as 24; and a computer 26 that is connected to server computer 30 via a RF link 28.

The computers that comprise the mobile units can be personal computers, notebook computers, handheld computers, or any other type of computer with sufficient memory and processing power to run the repair management software. Furthermore, any communication link between the mobile units and the server computer 30 that allows for transfer of digital data can be used in accordance with the present invention.

In a preferred embodiment, handheld computing devices 26 are used as the mobile units and are connected to the server computer 30 via a communication link. Each individual server computer 30 runs the repair management software in conjunction with the mobile units, as described further below. The technicians using the mobile units enter details related to an equipment repair order via the mobile units in place of handwritten, manual work orders. Labor, parts used, and any additional service details are entered into the system via the mobile unit, as described further below. The date and time of service, type of equipment, and length of repair work, are also contained on the order entry screen of the mobile units.

In a preferred embodiment, the server computer 30 is a personal computer that is connected to the mobile units through a network. The server computer 30 runs the administrative software and controls the administrative functions of the system, as described further below. The administrative functions include a front-office software package that can be utilized by an administrator to perform such functions as maintaining master table data, inventory, customer billing, and managing the networking of remote units running the repair management software. The administrative functions of the system allow for the storage and updating of customer requirements for estimates and purchase orders, and any other system requirements, freeing the technicians to simply enter repair data through the repair management software, creating more accurate orders for billing.

A description of the repair or service work performed is captured by the mobile unit through a series of job matrix codes that are defined specifically for the type of intermodal transportation equipment being serviced or repaired. The technicians are able to simply select the codes that describe the repair work through a series of list boxes on the screen of the mobile unit, as described below. The information can then be transmitted to the server computer 30 via the RF connection in accordance with information received from the central computer 10 for storage and integration into other software applications such as customer billing, inventory control, cost reporting, vendor processing and accounts payable, payroll and labor distribution.

In an alternate embodiment, desktop personal computers connected to the server computer 30 via either the LAN or directly through the global computer network are used for technicians operating in a shop environment. Furthermore, in an alternate embodiment, a printer can be included so that a printed copy of the service order form is available if desired.

A single mobile unit can be used by multiple technicians, wherein each technician has his or her own user id and password for the mobile unit with each technician logging onto the mobile unit. Also, a single technician may use multiple mobile units, such as, for example, a technician using a desktop personal computer when working in a shop and also using a handheld computer when performing work in the field. Finally, multiple technicians can share multiple mobile units. For example, a number of technicians may work in the same shop and the shop may be equipped with two or more mobile units. Any one of the technicians can use any one of the machines, and each technician has his or her own unique user id.

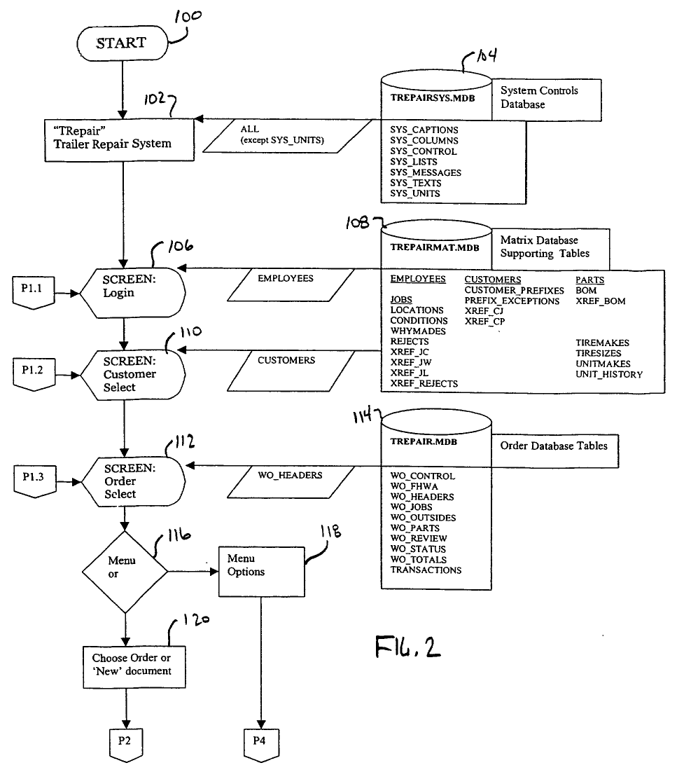

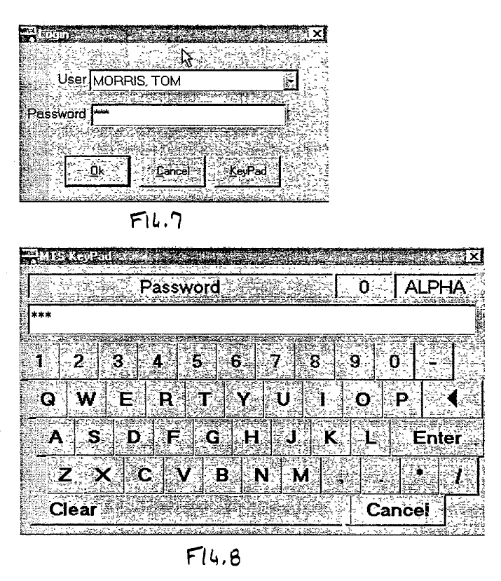

Referring now to FIGS. 2-6, flow diagrams are shown illustrating the steps of the repair management system through a series of screens that allow the technicians to control the flow of information to and from the mobile units. The screens and selection options will be described in more detail below with respect to the illustrations of the screens, FIGS. 7-26. The screens allow the flexibility of incorporating messages and/or default information on the screens of the mobile units, and also guide the transfer of information between the mobile units and the server computer 30. Referring first to FIG. 1, the system is started when the mobile unit is powered up at step 100. At step 102, the repair management system start screen is displayed, including, if desired, an orientation screen. At start-up, the mobile unit retrieves certain information from the System Controls Database 104. This information can either be stored directly on the mobile unit, or it can be retrieved from the server computer via the communication link.

Next, at step 106, the technician is prompted to enter his or her password that is associated with the specific user id. The Login Screen is shown in FIG. 7. As an alternate embodiment, a touch keyboard on the screen of the mobile unit can be included and used by the technician to enter information when activated, as is known in the art. Such a touch keyboard is shown in FIG. 8. This allows a handheld computing unit that does not incorporate a full keyboard to perform the full functionality of the system, further reducing the size of the handheld unit.

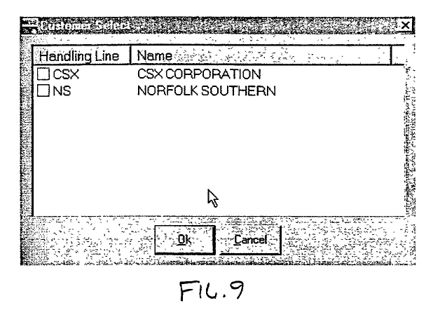

Information regarding the technician login is retrieved from Matrix Database Supporting Tables 108, including a determination of whether the technician is authorized and to verify that the correct password has been entered. After the technician has successfully logged into the system, the customer select screen 110 is displayed, and the technician chooses the customer for whom work will be performed. The customer select screen is shown in FIG. 9. After the customer is selected, the customer information is retrieved from the Matrix Database Supporting Tables 108.

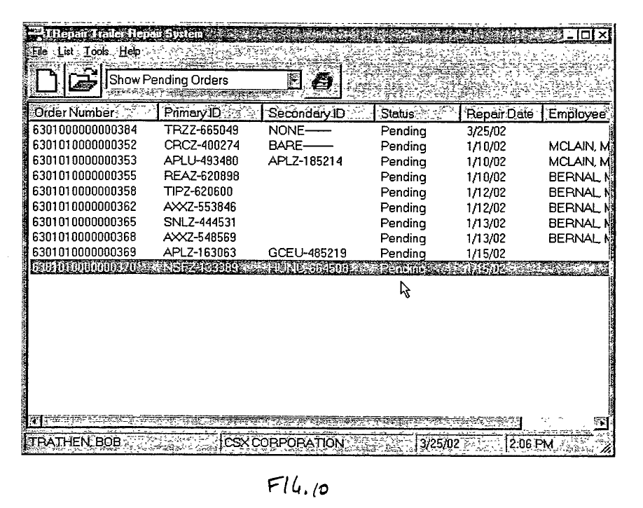

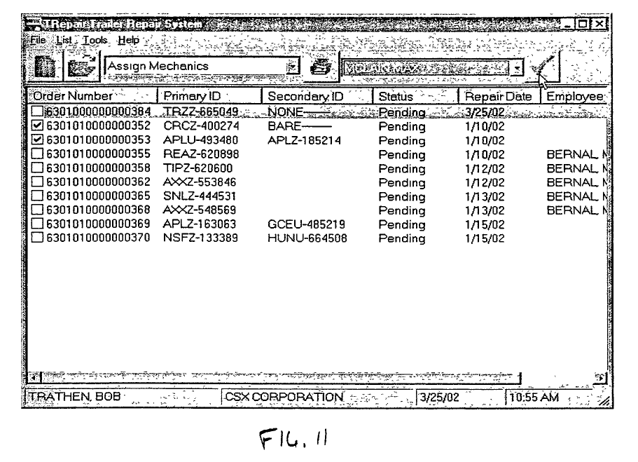

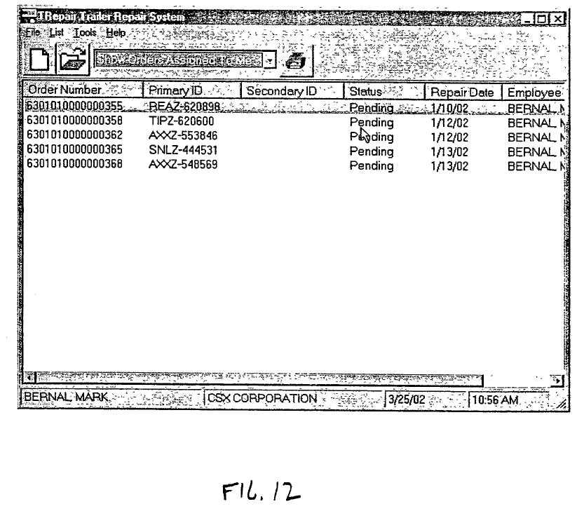

Next, after the customer is selected, the technician is prompted to select the order on which work is to be performed at step 112. In selecting the order, information is retrieved from the Order Database Tables 114. The order select screen 112 is shown in FIG. 10, and includes information such as the Order Number, the primary and secondary IDs of the order, status of the order, repair date, and employee assigned to the repair. In the screen shown in FIG. 10, all pending orders are shown. In alternate embodiments, the order select screen 112 displays all pending orders with the option to assign a technician to specific orders, as is shown in FIG. 11, or all orders assigned to the technician currently logged into the system, as shown in FIG. 12.

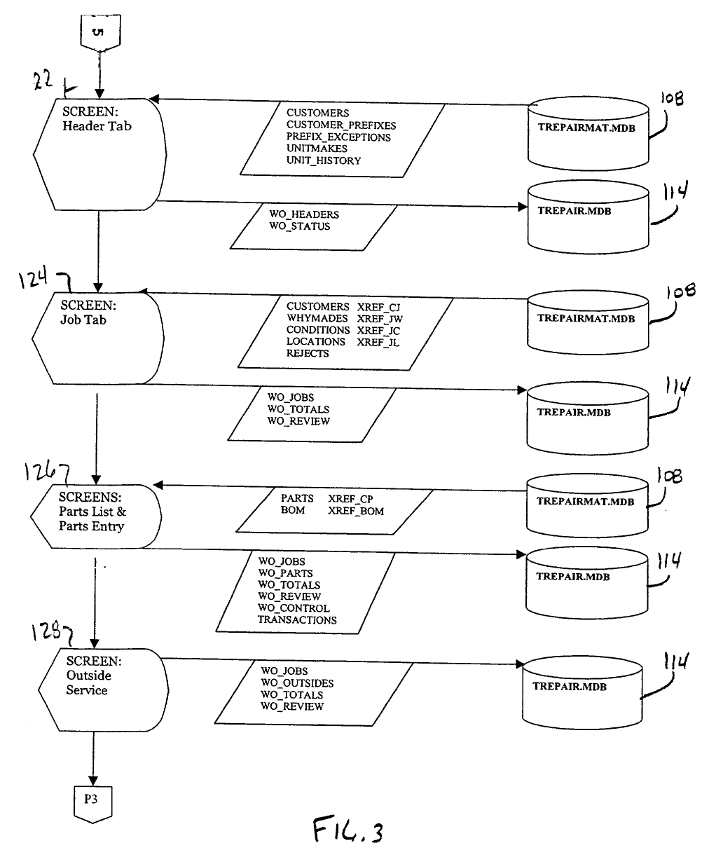

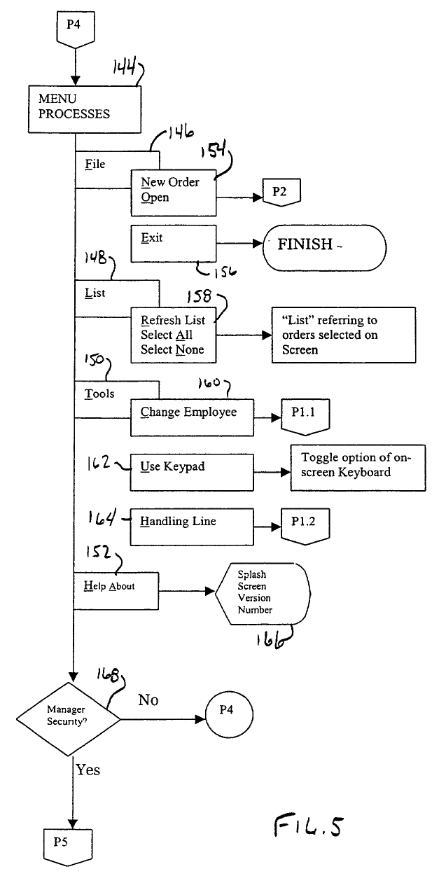

The technician next decides to either choose an existing order listed on the order select screen or select certain menu options at step 116. Should the technician choose an order or a “New” document from the menu (as described further below) at step 120, the system continues at P2 to FIG. 3. Should the technician select the menu options at step 118, the system continues at P4 to FIG. 5, described further below.

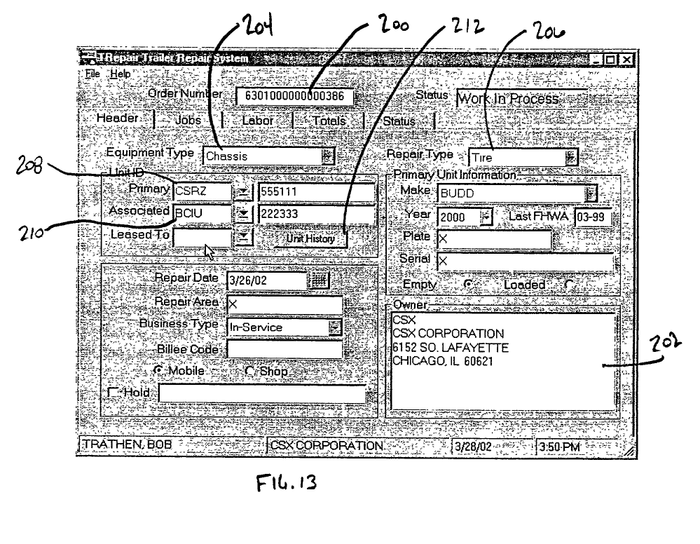

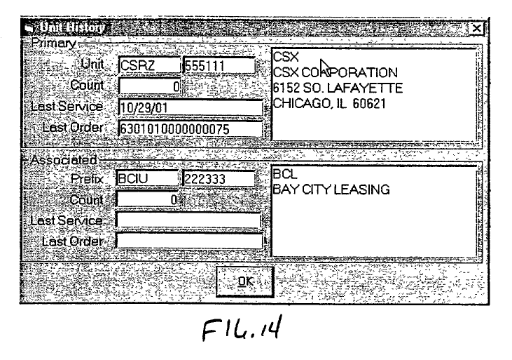

Referring now to FIG. 3, the header tab screen 122 is displayed after the technician either selects an existing order or a new document at step 120. In association with this screen, information is transferred from the Matrix Database Supporting Tables 108 to be displayed on the screen, and information is transferred to the Order Database Tables 114 that is entered by the technician. The header tab screen is shown in FIG. 13. This is the first screen for order processing, and the selected order is displayed in the Order Number box 200. The Matrix Database Supporting Tables 108 supply information to fill in certain fields of the header tab screen, such as the “Owner” box 202. The Equipment Type box 204 and Repair Type box 206 will display information associated with the particular order number selected. The Unit ID of the unit to be repaired is shown in box 208 (with an associated Unit ID shown in box 210). The history of the unit to be repaired can be accessed by activating the Unit History button 212, which will call up the Unit History screen shown in FIG. 14. Information entered on the header tab screen 122 by the technician, such as repair date and area, is transmitted to the server computer for storage and future use.

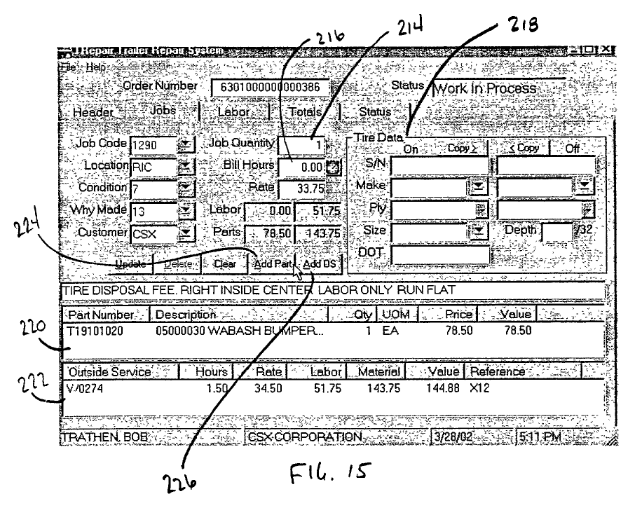

After the Equipment Type and Repair Type fields are completed in the header tab screen 122, the jobs tab screen 124 is activated by clicking on the Jobs tab. The information contained in the Equipment Type and Repair Type fields limits the list of jobs available in the jobs tab screen 124 to those applicable for repairing that type of equipment. The jobs tab screen is shown in FIG. 15; however, FIG. 16 illustrates how the jobs tab screen appears when it is first activated. Specifically, a select code window 214 is displayed which displays a list of repairs that are directed to the equipment type and repair type information from the header tab screen 122. The technician can then select from the listed repair types, and the system will then return to the jobs tab screen (FIG. 15). The technician can only select codes that are valid for the equipment type and repair type being worked on, as selected in the header tab screen (FIG. 13).

As shown in FIG. 15, the jobs tab screen include various fields where information is input by the technician. Certain of these fields will have default information automatically input depending on the equipment type and repair type input on the header tab screen. For example, the job quantity field 214 defaults to 1, and the bill hours field 216 defaults to the maximum allowed hours for the selected job. Any of these defaults can be overridden by the technician, so that different values can be input rather than the default values. In addition, custom screens can be displayed, such as thee tire data 218 portion of the screen, which is displayed only if the job codes indicate that a tire is being repaired. Fields at the bottom of the jobs tab screen display parts 220 and outside service information 222.

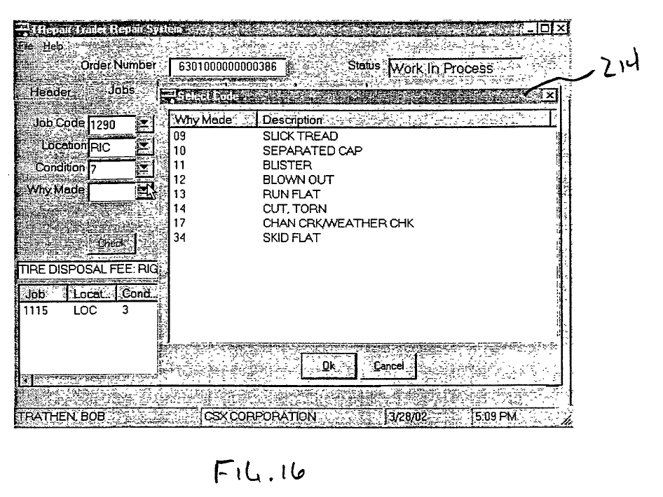

Parts may be automatically assigned to the job if a parts list has been established for the job, and a Part List Selection screen is displayed, as is shown in FIG. 17. Parts can also be added to the parts field by activating the Add Part button 224. Referring to FIG. 3, when the Add Part button 224 is activated (FIG. 15), the flow chart proceeds to the Parts List and Parts Entry screen 126. When this screen is activated, the system receives information from the Matrix Database Supporting Tables 108 and information is transmitted to the Order Database Tables 114.

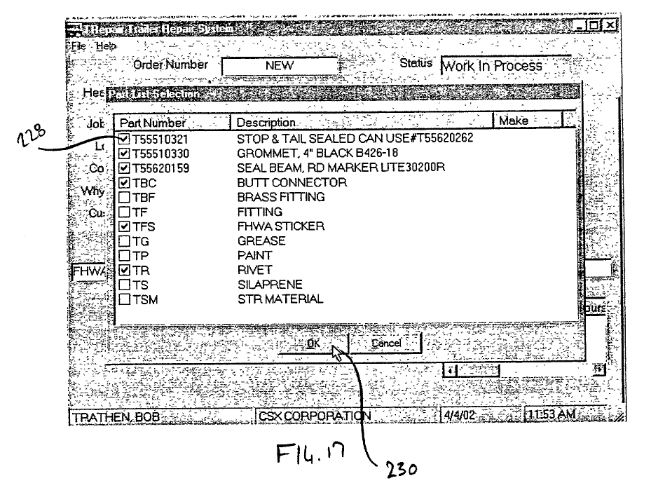

Referring again to FIG. 17, the parts that are displayed on the Part List Selection screen default to all parts that may be necessary for the job being performed. The technician can simply click on the boxes of the parts that are needed for a specific job, and then click the OK button 230. The selected parts will automatically be displayed in the parts field 220 when OK button 230 is activated. In an alternate embodiment, when the Add Part button 224 is activated, a part entry portion of the screen is displayed, as shown in FIG. 18. The technician can either input the necessary parts manually, or can activate the button 232 next to the part field.

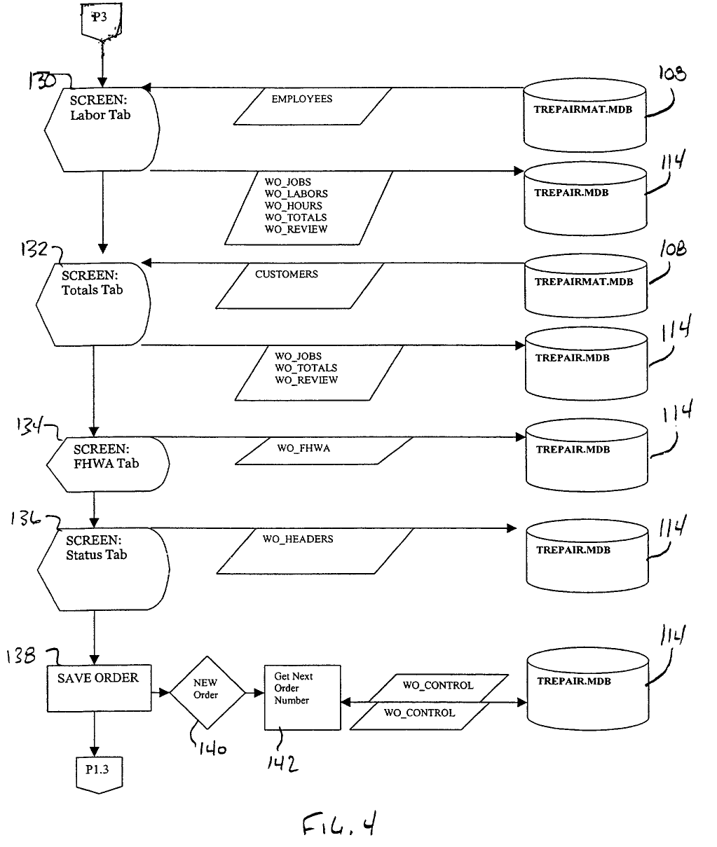

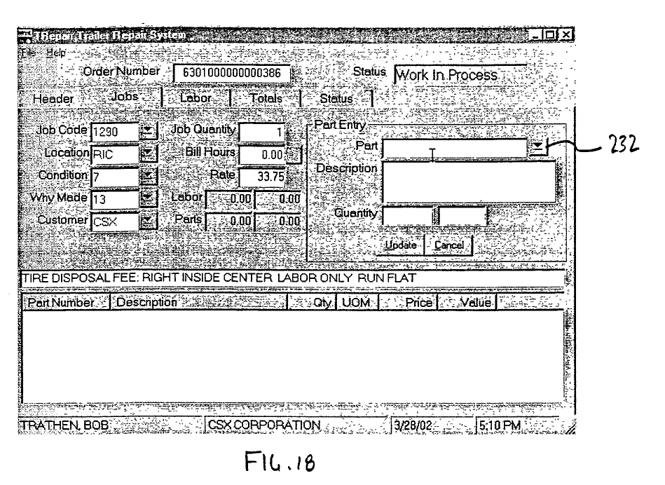

Similarly, when the Add OS button 226 is activated in FIG. 15, the screen illustrated in FIG. 19 is displayed. Referring to FIG. 3, when the Add OS button 226 is activated (FIG. 15) the flow chart proceeds to the Outside Service screen 128. When this screen is activated, the system transmits information to the Order Database Tables 114. Referring again to FIG. 19, the technician can then input information about outside service vendors into the fields for Outside Service 234. After the information is input, the Update button 236 is activated and the Outside Service field 222 (shown in FIG. 15) is updated with the additional information. The system then moves along to P3, shown in FIG. 4.

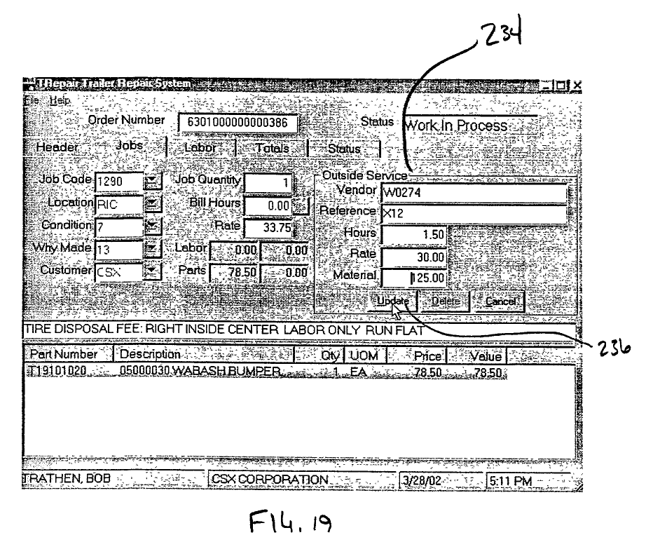

After the information is input on the jobs tab screen, the technician activates the labor tab screen 130, which is shown in FIG. 20. The labor tab screen 130 is used to record the actual time of the technician in performing the job. This screen may be used to override the bill hours field 216 on the jobs tab screen shown in FIG. 15. In association with this screen, information is transferred from the Matrix Database Supporting Tables 108 to be displayed on the screen, and information is transferred to the Order Database Tables 114 that is entered by the technician. The technician enters the date work is performed in field 238, and the hours worked in field 240. In an alternate embodiment, the technician can simply click on the timer button 242 when work begins and again when work is completed, and the total time will automatically be inserted to field 240. Also, the technician can enter the start time in field 244 and the stop time in field 246, and the total time will automatically be inserted to field 240. Finally, the technician who performed the work is entered into field 248. The information entered is transmitted to the Order Database Tables 114, shown in FIG. 4.

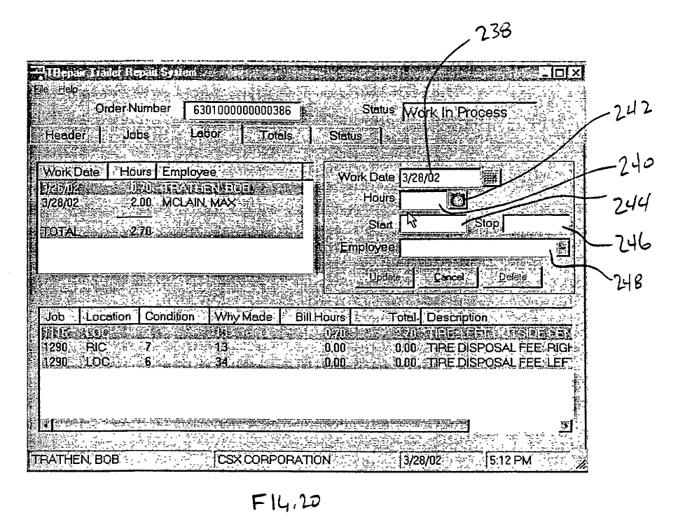

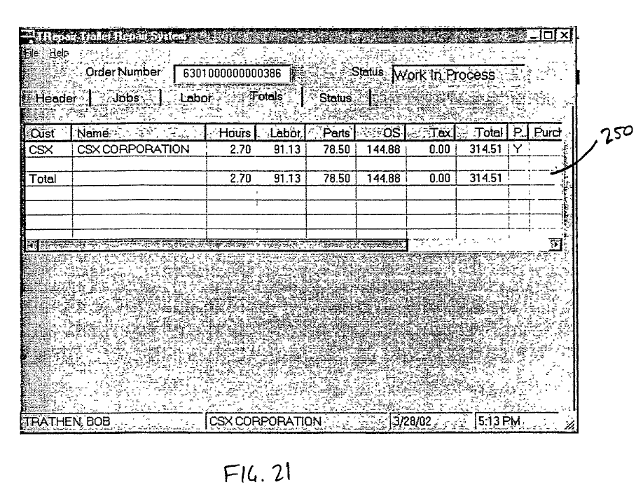

Next, the technician enters the totals tab screen 132, which screen is shown in FIG. 21. When this screen is accessed, customer information is transmitted from the Matrix Database Supporting Tables 108 for display. The totals tab screen 132 displays order summaries broken down by customer billed in field 250. Orders may have multiple customers, for example, each job code within a repair may have a different customer. The information contained in the display 250 is automatically generated based upon information entered in the jobs tab screen and the labor tab screen. This information can be modified or added to by double-clicking on a specific order in field 250, which will then activate additional fields at the bottom of the screen, as shown in FIG. 22. In these additional fields, information can be updated. As information is updated, such updated information is transmitted to Order Database Tables 114, as shown in FIG. 4.

In an alternate embodiment, the technician can then enter the FHWA tab screen 134, which is shown in FIG. 23. This screen allows the entry of data required by the Federal Highway Administration. In the past, this information has been manually entered on a form, which then must be transmitted to the Federal Highway Administration. After entering the information required by the Federal Highway Administration, the information is transferred to the Order Database Tables 114, where it can either be printed and sent to the Federal Highway Administration, or potentially transmitted electronically.

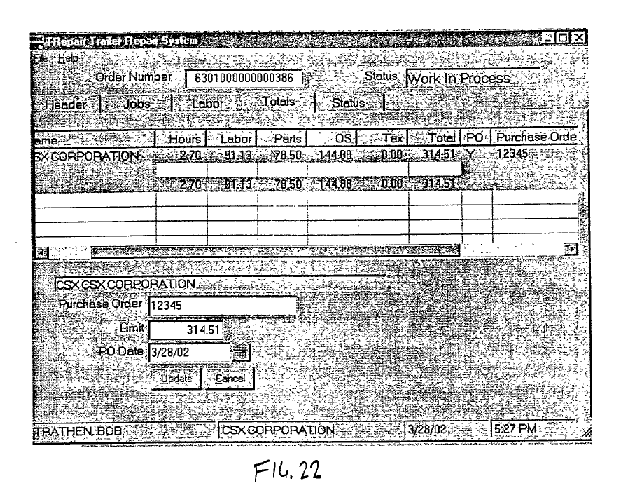

After the information about a specific repair order has been entered as described above, the status tab screen 136 is accessed. This screen is shown in FIG. 24, and the screen displays any overrides of default values made by the technician, allowing a manager to easily review all such overrides made by the technician. After the manager reviews and approves of all default overrides, the order is approved, and information is transmitted to the Order Database Tables 114, as shown in FIG. 4. Then, the technician can save the order at 138. If the order has previously been saved, it will save in the same file, and the system will proceed to P1.3, allowing the next order to be selected as shown in FIG. 2, step 112. The system will then proceed as described above for the next order. However, if at step 138, the order is being saved as a new order, the system proceeds to step 140, the new order step. The system retrieves the next available order number from the Order Database Tables 114 at step 142, and saves the order under the next available order number. The system will proceed to P1.3, allowing the next order to be selected as shown in FIG. 2, step 112. The system will then proceed as described above for the next order.

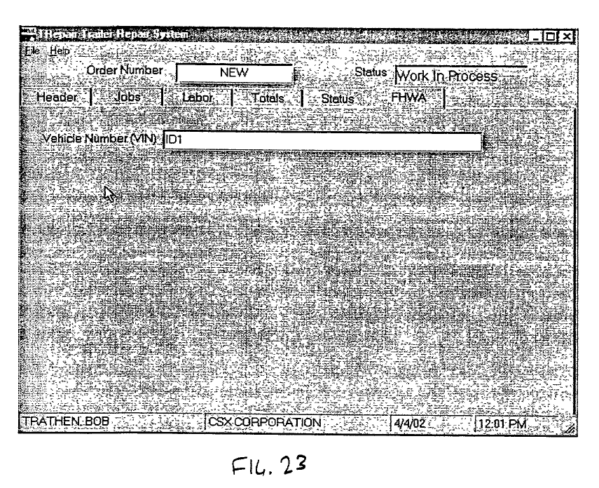

Referring again to FIG. 2, should the technician choose the menu options at step 116 rather than choosing an order when in the order select screen 112, the system proceeds to step 118, which is the menu options, as shown in FIG. 25. The system then proceeds to P4, shown in FIG. 5. At the menu processes step 144, the technician can choose between the file pulldown menu 146, the list pulldown menu 148, the tools pulldown menu 150, or the help/about pulldown menu 152 at the top of the screen. From the file pulldown menu 146, the technician can open either a new or existing order at step 154, in which case the system proceeds to P2, and begins again at step 122 shown on FIG. 3 and proceeds as described above. The technician can also choose to exist the system at step 156 from the file pulldown menu 146, which will terminate the program.

The technician could also select the list pulldown menu 148, which allows the technician to choose to refresh the list shown on the order select screen 112, the technician can select all of the orders currently shown on the order select screen 112, or can select none of the orders currently shown on the order select screen 112 at step 158. This will allow the technician to choose the appropriate order at step 116.

If the technician selects the tools pulldown menu 150, the technician will be able to choose between the change employee option 160, the use keypad option 162 and the handling line option 164. If the technician chooses to change employee at step 160, the system proceeds to P1.1, allowing new employee information to be input as shown in FIG. 2, step 106. The system will then proceed as described above using the information for the new employee who has logged in. If the technician chooses to use the keypad at step 162, the touchscreen keypad shown in FIG. 8 is activated for use by the technician. Finally, if the technician chooses the handling line at step 164, the system proceeds to P1.2, allowing new customer information to be input as shown in FIG. 2, step 110. The system will then proceed as described above using the information for the new customer that has been selected. Should the technician choose the help/about pulldown menu 152, information will be shown about the program at step 166.

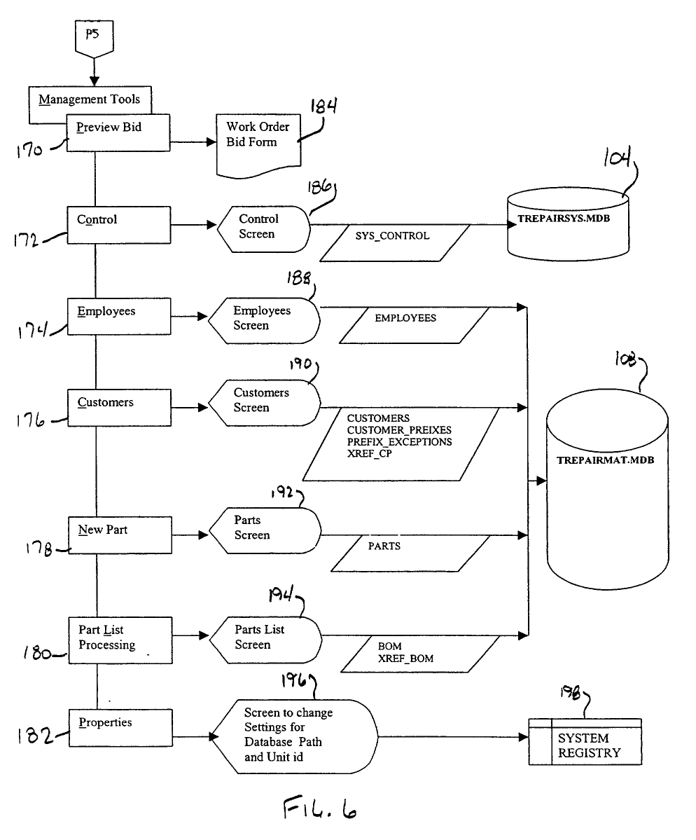

Finally, should the user choose the management tools option from the tools pulldown menu 150, the system will verify that the user has authorization to use this option by checking manager security at step 168. If the user does not have authorization to access these options, the system returns to P4 and the menu processes at step 144. However, if the user is authorized to access the management tools, the system proceeds to P5 and the management tools shown in FIG. 6. The user can then select from the preview bid option 170, the control option 172, the employees option 174, the customers option 176, the new part option 178, the part list option 180 and the properties option 182. Many of these options are discussed in more detail below with respect to the administrative portion of the present invention.

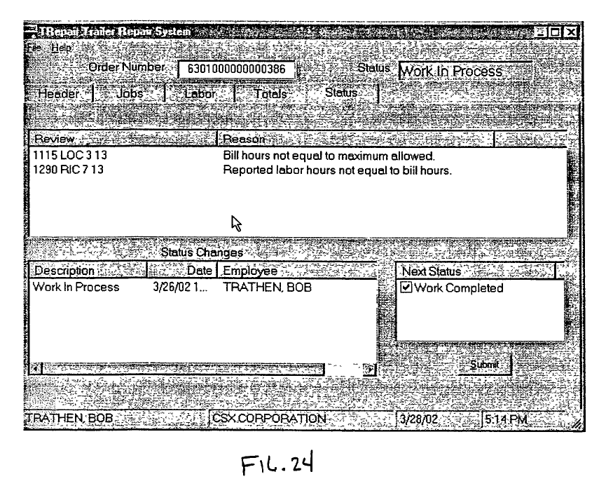

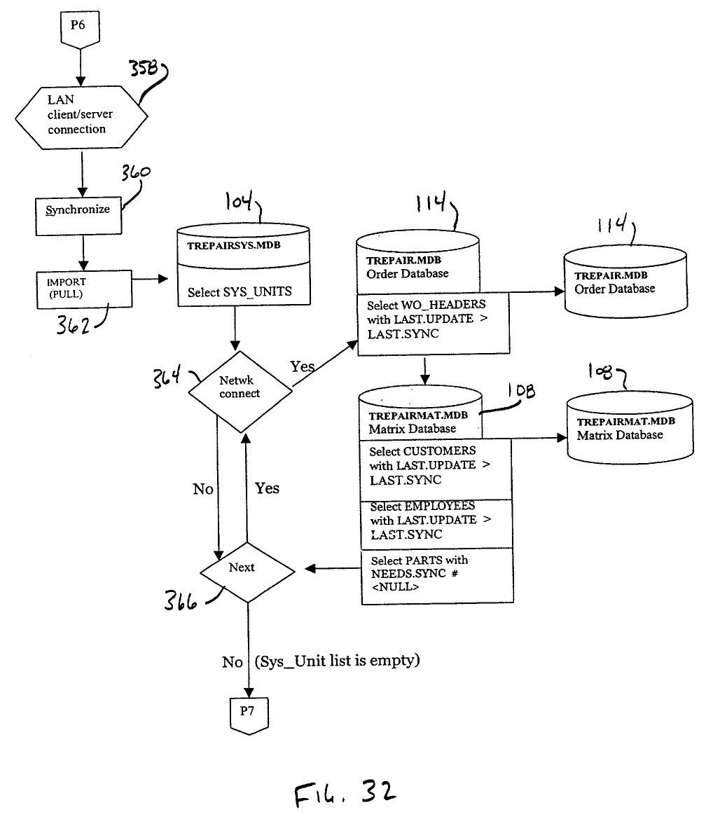

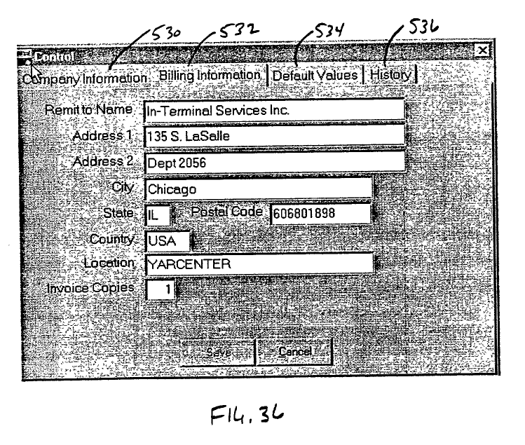

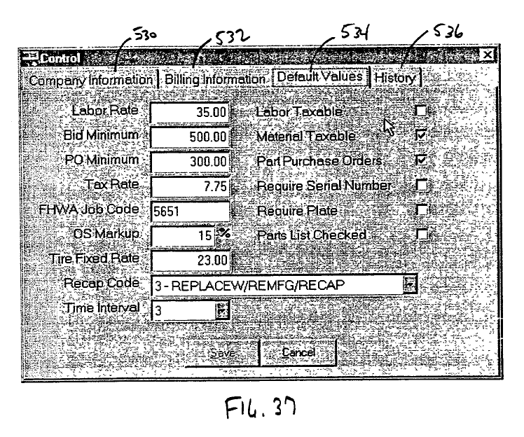

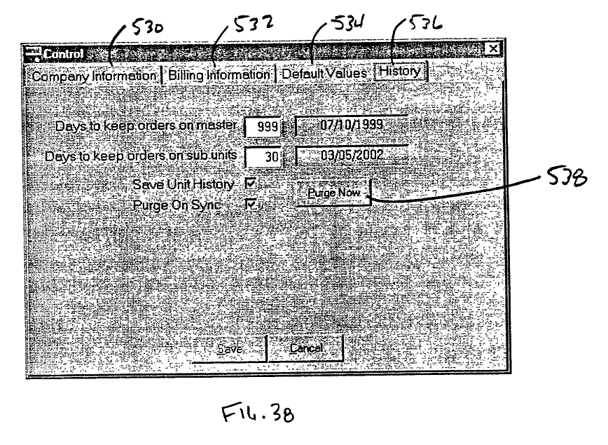

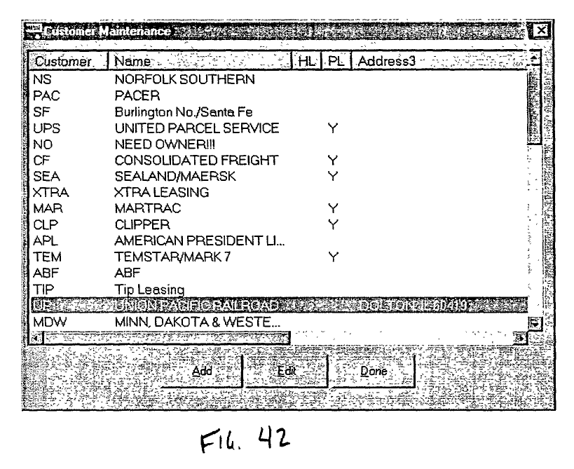

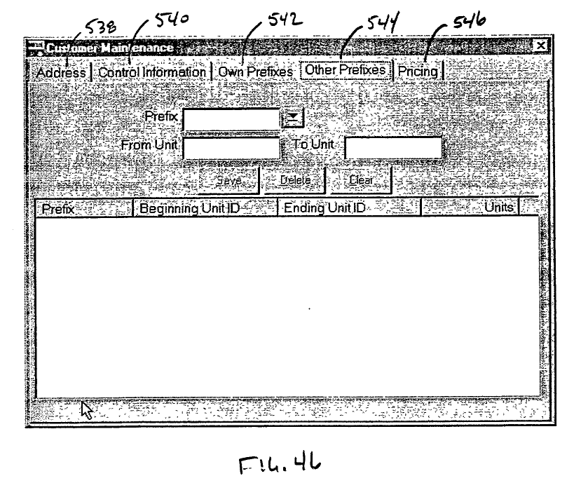

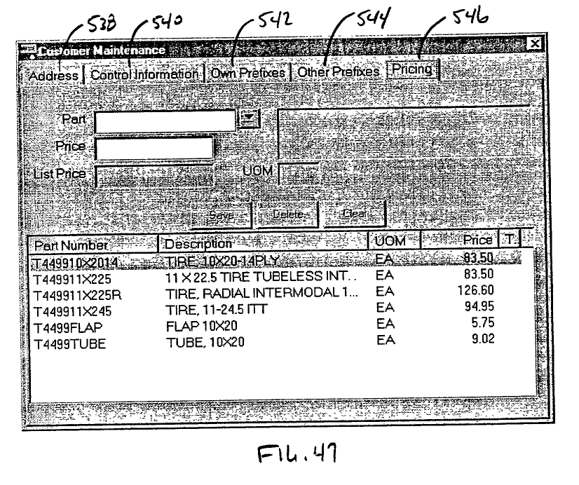

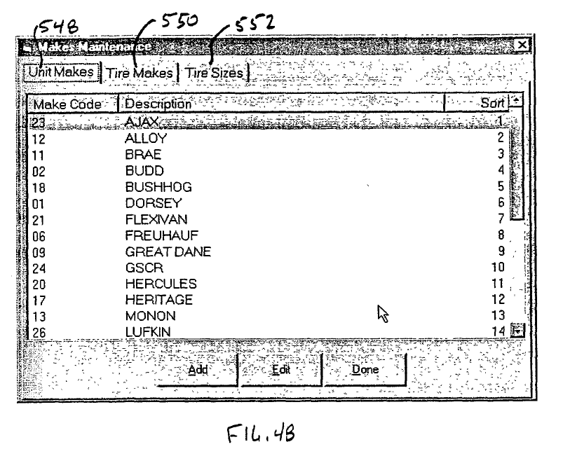

When the preview bid option 170 is selected, the work bid order form 184 is displayed, as shown in FIG. 26. When the control option 172 is selected, the control screen 186 is displayed, as shown and described in more detail with respect to FIGS. 35-38. When the employees option 174 is selected, the employees screen 188 is displayed, as shown and described in more detail with respect to FIGS. 40-41. When the customers option 176 is selected, the customers screen 190 is displayed, as shown and described in more detail with respect to FIGS. 42-47. When the new part option 178 is selected, the parts screen 192 is displayed, as shown and described in more detail with respect to FIGS. 51-52. When the part list processing option 180 is selected, the parts list screen 194 is displayed, as shown and described in more detail with respect to FIGS. 53-56. Finally, if the properties option 182 is selected, the user is able to modify certain settings of the remote unit at step 196, and these modifications are reflected in the system registry at step 198.

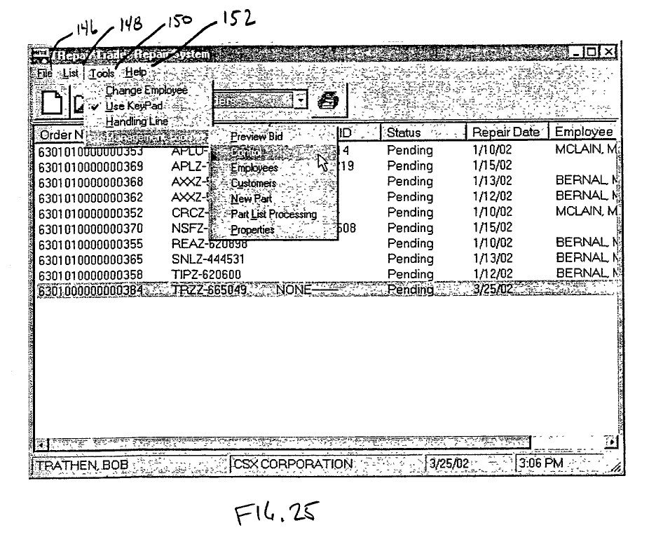

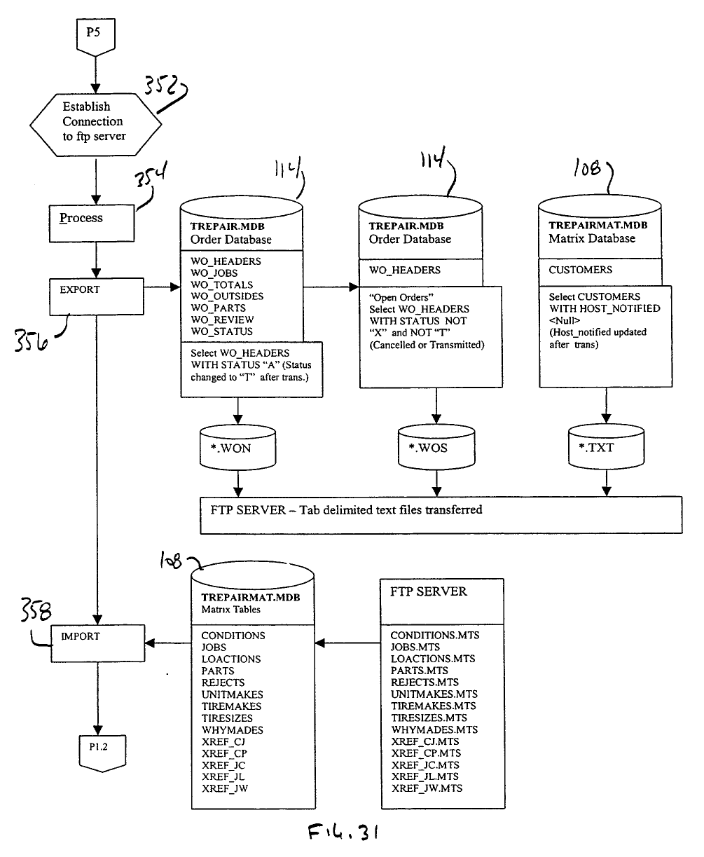

Referring now to FIGS. 27-33, flow diagrams are shown illustrating the steps of the administrative system through a series of screens that allow an administrator to control the flow of information to and from the mobile units. More specifically, the administrative system generally controls the flow of information between the server computer 30 and various mobile units. The screens and selection options of the administrative system will be described in more detail below with respect to the illustrations of the screens, FIGS. 34-84. The screens allow the flexibility of incorporating messages and/or default information on the screens of the server computers 30 and the mobile units, and also guide the transfer of information between the server computers 30 and the mobile units.

Referring now to FIG. 27, the administrative system is started when the unit is powered up at step 300 and the primary administration system is entered at step 302. At this step, the system receives information from the System Controls Database 104. Next, the login screen 304 is displayed, which is shown in FIG. 8. At the login screen, information is received by the system from the Matrix Database Supporting Tables 108. After successful login, the main administration screen is displayed, which is illustrated as FIG. 34.

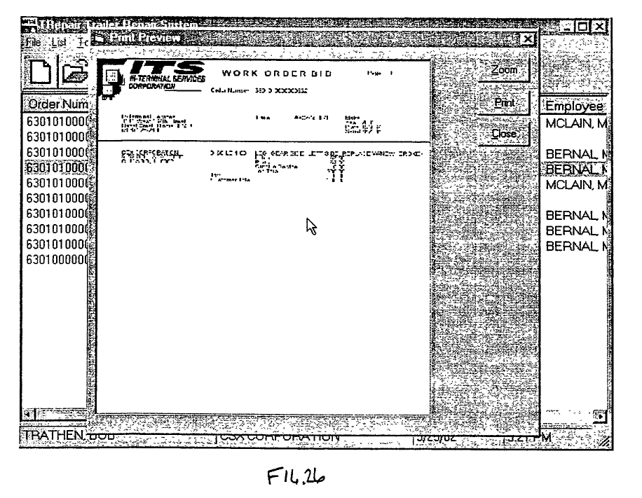

From the main administration screen, the Maintain Tables tab screen 306 may be selected by clicking on the Maintain Tables tab 502. In the Maintain Tables tab screen 306, the user can select from three groups of selections—System tables 308, Matrix tables 310, and Transactions 312. If the user is selecting options under System Tables 308, the system moves to P2, which is shown in FIG. 28. The user can select the Control screen 320 by clicking on the Control button 504 shown on FIG. 34. The tab screens related to the Control screens 320 are shown in FIGS. 35-38. This allows maintenance of the System Controls Database 104 through input of information in these screens, and the central set of parameters entered for a specific company controls the way the software functions. As information is input to the system through the Control screens 320, as described below, the System Controls Database 104 is updated.

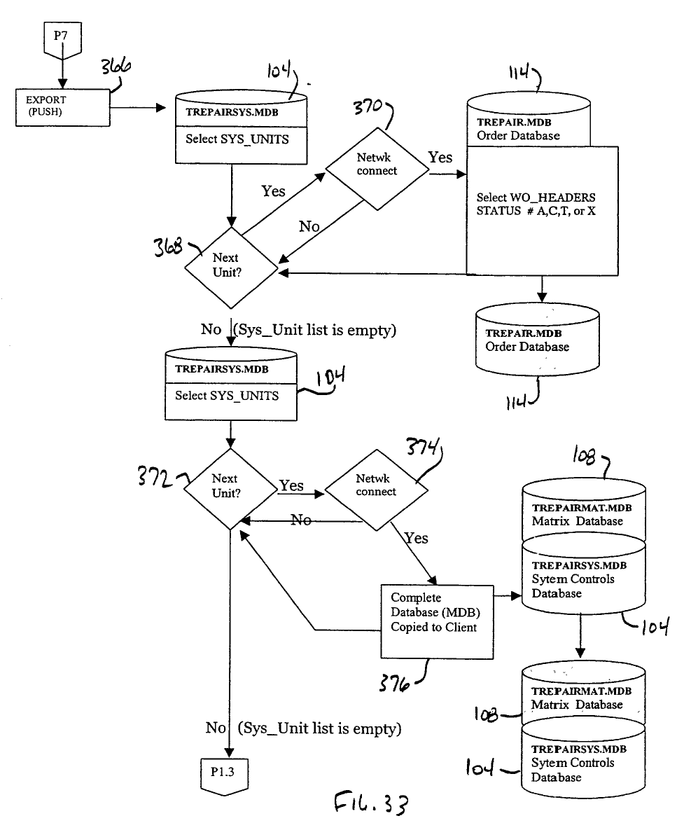

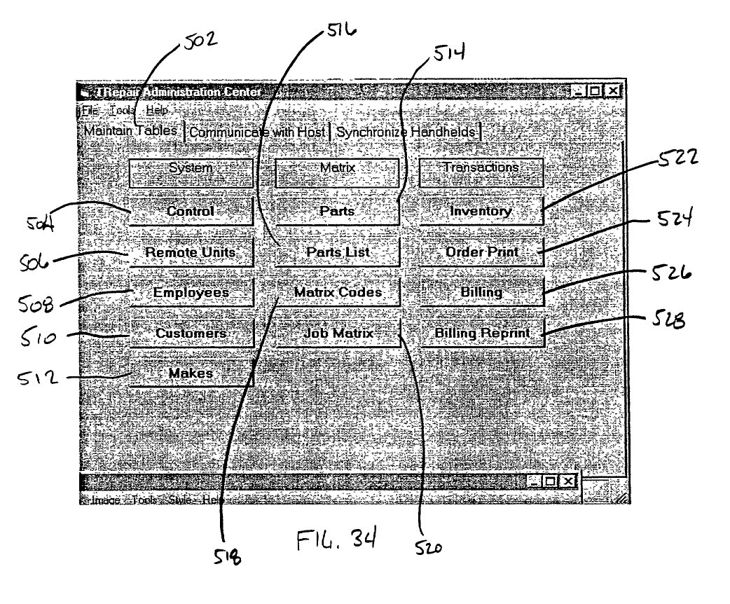

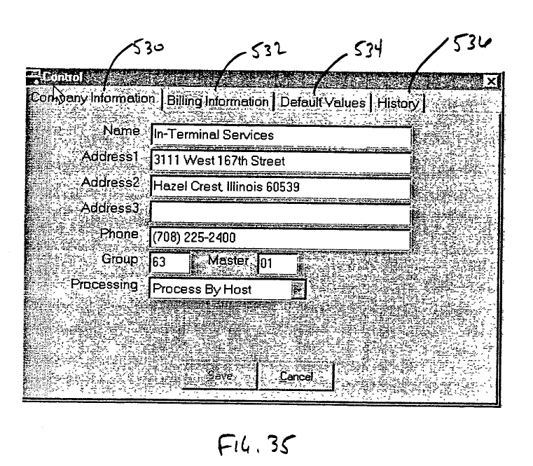

Referring to FIG. 35, when the Company Information tab 530 is clicked, information about the specific company whose parameters are being updated are shown, and can be modified. When the Billing Information tab 532 is clicked, billing information for the specific company is shown and can be modified, as shown in FIG. 36. When the Default Values tab 534 is clicked, information about any default values for a specific company are shown and can be modified, as shown in FIG. 37. For this screen, certain information, including the labor rate, bid minimum, PO minimum, OS markup and tire fixed rate, is also maintained in the Matrix Database Supporting Tables 108, and if values conflict, the values in the Matrix Database Supporting Tables 108 control. Finally, when the History tab 536 is clicked, the screen illustrated in FIG. 38 is shown. This screen allows the user to set parameters for the length of time order history will be retained in the system, both on the server computers 30 and the mobile units. This screen also gives the option to purge the entire history of a company immediately through the Purge Now button 538.

Referring again to FIGS. 28 and 34, the Remote Units screen 322 can be accessed by clicking on the Remote Units button 506. The Remote Units screen is shown in FIG. 39, and allows the entry of the network path for any of the server computers. The network path is required for the synchronize handheld process. The entry of information in the Remote Units screen 322 updates the System Controls Database 104.

The Employees screen 324 is accessed by clicking the Employees button 508, and the Employees screen 324 is displayed, as shown in FIG. 40. The screen displays a list of employees, and serves as both an employee list for labor entry, and as a user identification file for entry into the repair system and the administration system. Note that this screen includes a language designation, allowing for multilingual users to access the system. When one of the employees displayed on FIG. 40 is double-clicked, the screen illustrated in FIG. 41 is displayed, including information specific to that selected employee. In this screen, the name of employees, the employee password, and employee number can be accessed and revised. Also, the employee is assigned one or more roles, and the employees access to certain aspects of the system depends on the employees assigned roles. The entry of information in the Employees screen 324 updates the Matrix Database Supporting Tables 108.

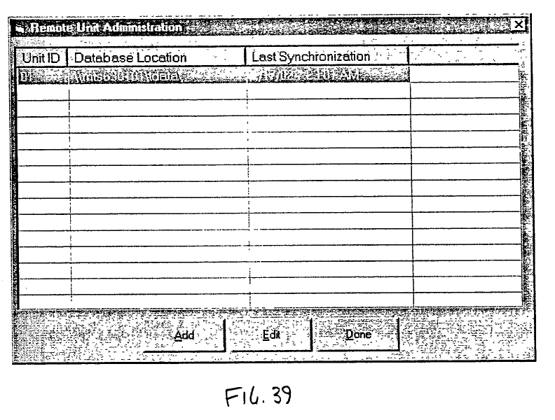

The Customers screen 326 is accessed by clicking the Customers button 510, and the Customers screen 326 is displayed, as shown in FIG. 42. The screen displays a list of customers, and the customer information can be edited by highlighting the customer and clicking the Edit button, or a new customer can be added by clicking the Add button. In either case, various tab screens are accessed and displayed to input information regarding the customers, as illustrated in FIGS. 43-47. The entry of information in the subsequent Customers data entry screens 326 updates the Matrix Database Supporting Tables 108.

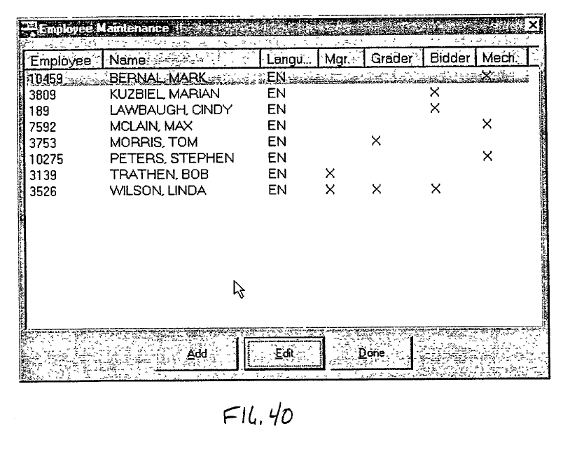

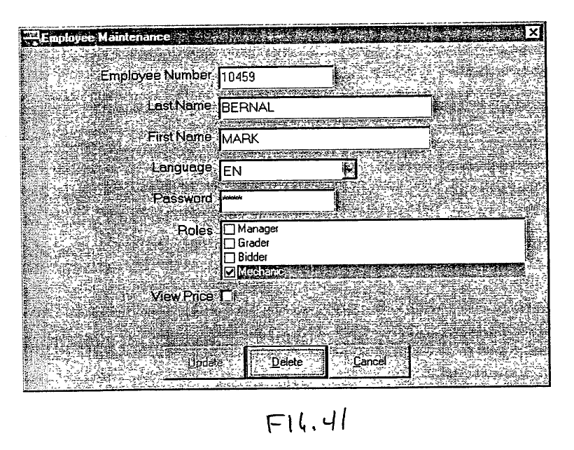

Referring to FIG. 43, the address screen for the customer is displayed when the Address tab 538 is clicked. This allows for the input and modification of a customer's name and address. FIG. 44 illustrates the control information screen that is accessed by clicking the Control Information tab 540 in the Customer screen 326. This inputs information for the selected customer, including whether the customer should be taxed for parts and labor, whether actual labor time must be entered for all jobs before the status of an order can be changed to complete, and whether tire repair is at a fixed rate or an hourly rate. If it is to be billed at a fixed rate, that rate can be input on this screen. FIG. 45 illustrates the own prefixes screen that is accessed by clicking the Own Prefixes tab 542 in the Customer screen 326. This screen assigns unit prefixes to the specified customer to determine ownership of unit for billing. If the Requires PO box is checked, a customer purchase order will be required on order repairs to equipment with this prefix, regardless of the dollar value of the order. FIG. 46 illustrates the other prefixes screen that is accessed by clicking the Other Prefixes tab 544 in the Customer screen 326. This screen enables assignment of a range of Unit Numbers within a prefix assigned to the specified customer. The prefix must be on the Own Prefixes list for a different customer. If repair is made to a unit within the range for this prefix, the customer will be treated as owner. Finally, FIG. 45 illustrates the pricing screen that is accessed by clicking the Pricing tab 546 in the Customer screen 326. This screen allows special customer pricing on specific part records to be entered. The special pricing is only required if the customer part price differs from the price entered in the Matrix Database Supporting Tables 108. If a customer price is entered here, it will take precedence over the Matrix Database Supporting Tables 108.

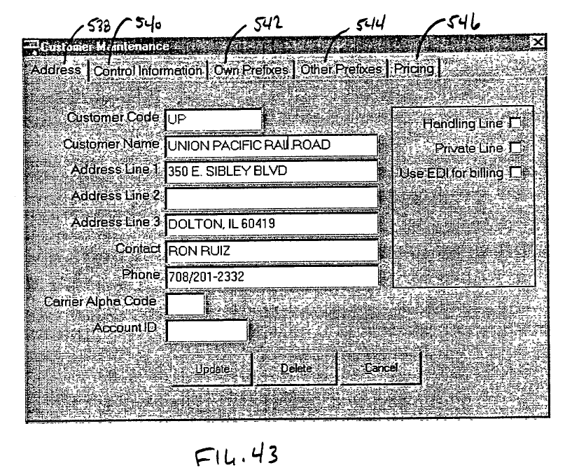

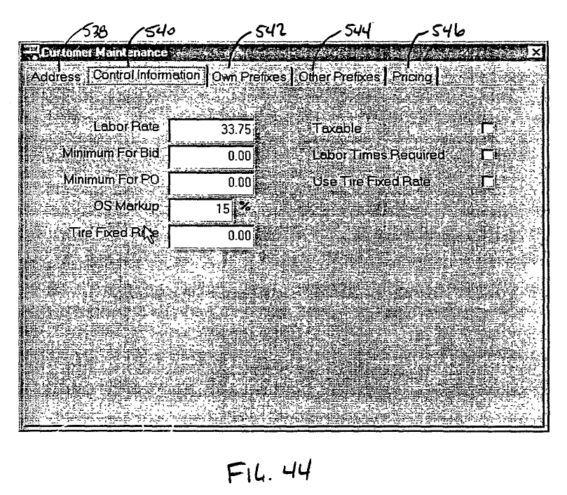

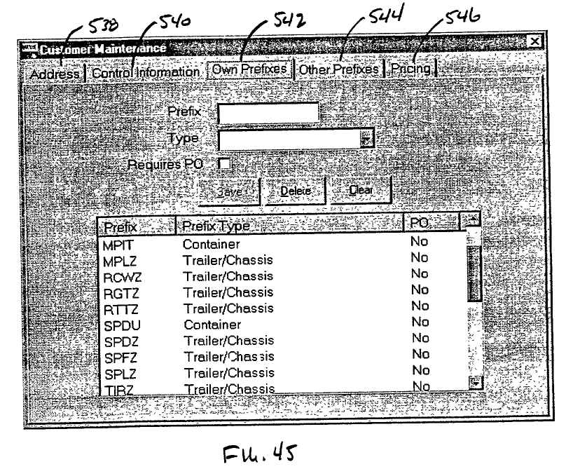

Referring again to FIGS. 28 and 34, the Makes screen 328 is accessed by clicking the Makes button 512, and the Makes screen 328 is displayed, as shown in FIG. 48. The screen displays a list of unit makes of various parts when the Unit Make tab 548 is clicked, and the makes information can be edited by highlighting the make and clicking the Edit button, or a new make can be added by clicking the Add button. In addition, FIGS. 49 and 50 show the screens displayed when the Tire Makes tab 550 and Tire Sizes tab 552 are clicked, respectively. The entry of information in the subsequent Makes data entry screens 328 updates the Matrix Database Supporting Tables 108. After the information has been input to the Makes screen 328, the system continues to P1.1, as shown in FIG. 27, and then again proceeds to the Maintain Tables tab screen 306, illustrated in FIG. 34.

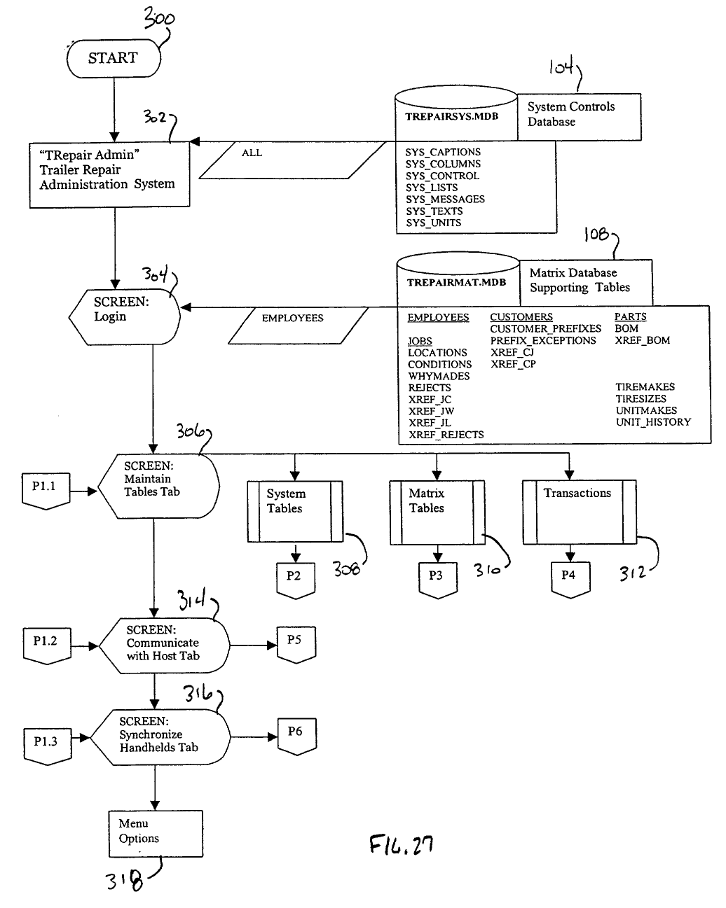

From the Maintain Tables tab screen 306, the user can select options under Matrix Tables 310, the system moves to P3, which is shown in FIG. 29. The user can select the Parts screen 330 by clicking on the Parts button 514 shown on FIG. 34. This will display the Parts screen 330, illustrated in FIG. 51. The screen displays a list of parts, and the parts information can be edited by highlighting a part and clicking the Edit button, or a new part can be added by clicking the Add button. In either case, the parts edit screen illustrated in FIG. 52 is displayed that allows a part to be assigned to a specific manufacturer or “make” code (see above). Also, certain properties can be selected on this screen, such as the Requires PO selection, which, if checked, makes the customer purchase order a required entry when the part is used. The entry of information in the parts data entry screen updates the Matrix Database Supporting Tables 108.

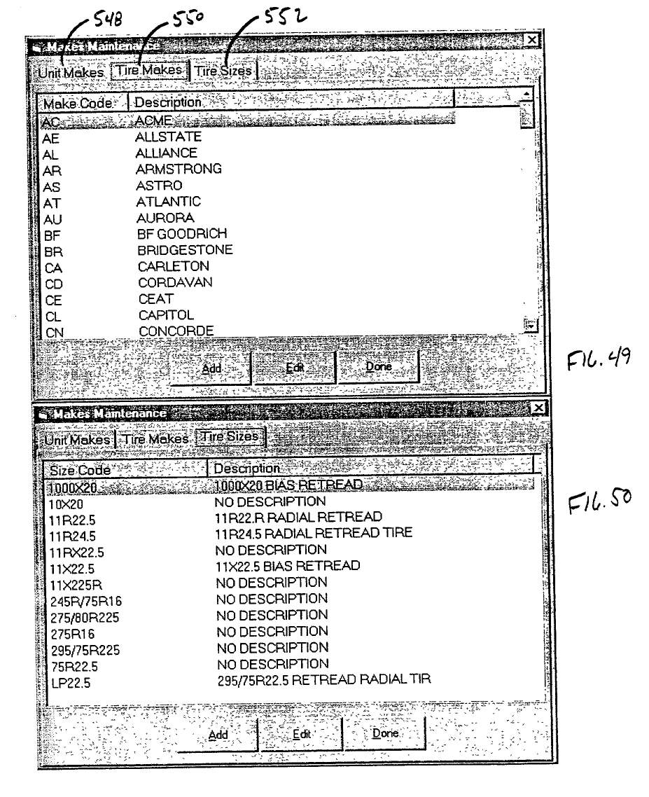

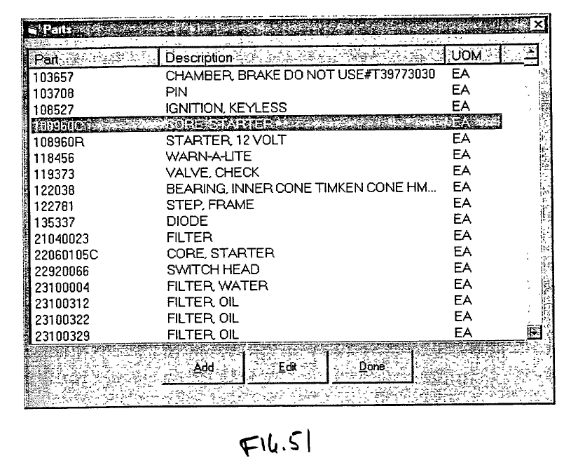

Next, the user can select the Parts List screen 332 by clicking on the Parts List button 516 shown on FIG. 34. This will display the Parts List screen 332, illustrated in FIG. 53. The screen displays a list of parts, and a list of these parts will be generated to prompt the user for parts to be used on a specific job. Information about the parts list can be edited by highlighting a part and clicking the Edit button, or a new part can be added to the list by clicking the Add button. In either case, the parts list edit screen illustrated in FIG. 54 is displayed wherein the component tab 554 is clicked to associate a list of related component parts. Quantities are assigned to each component. When the Jobs tab 556 is clicked, the screen illustrated in FIG. 55 is displayed. On this screen, the job combinations that the selected part belongs to are listed. Information about the job combinations can be edited by highlighting an existing line and clicking the Edit button, or a new job combination can be added to the list by clicking the Add button. In either case, the parts list maintenance screen illustrated in FIG. 56 is displayed In this screen, the parts list can be associated with certain repairs, conditions and locations to automatically prompt the user in the future when the specific combination is present. The entry of information in the parts list data entry screens updates the Matrix Database Supporting Tables 108.

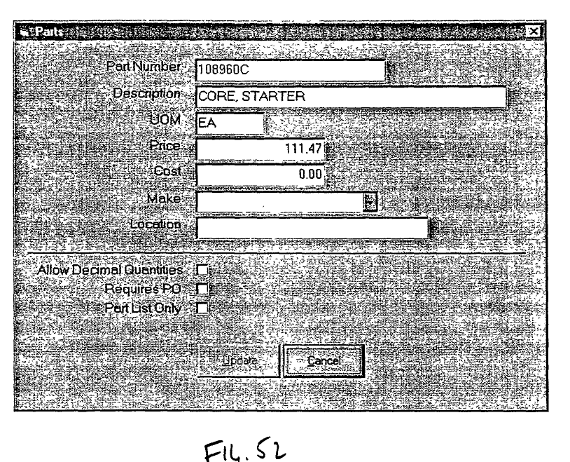

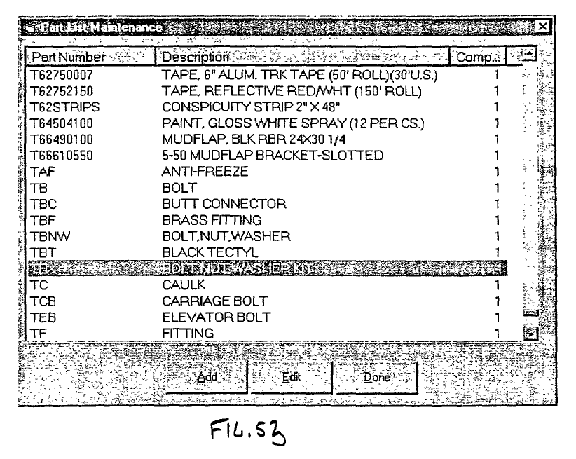

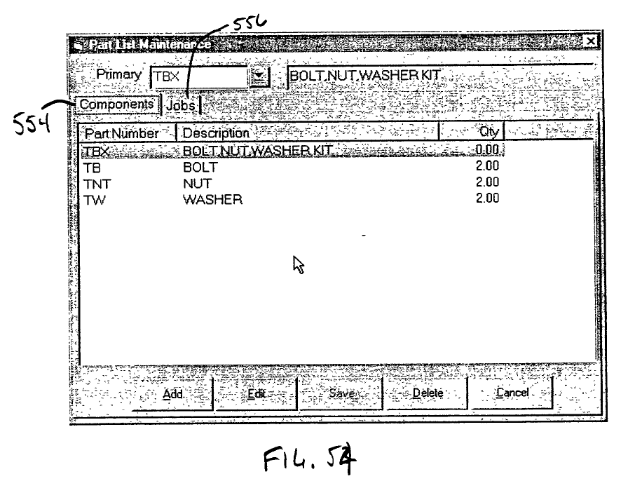

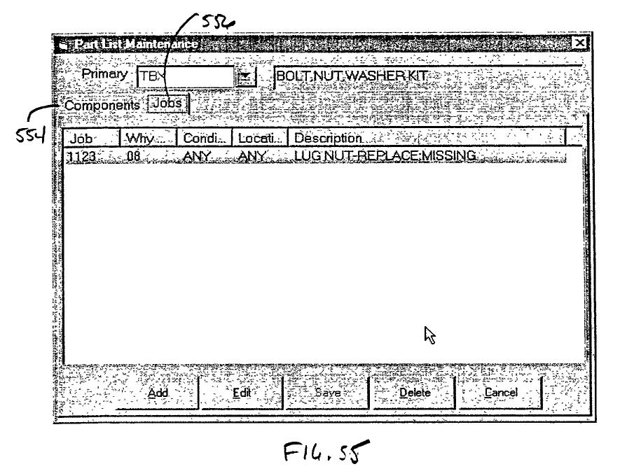

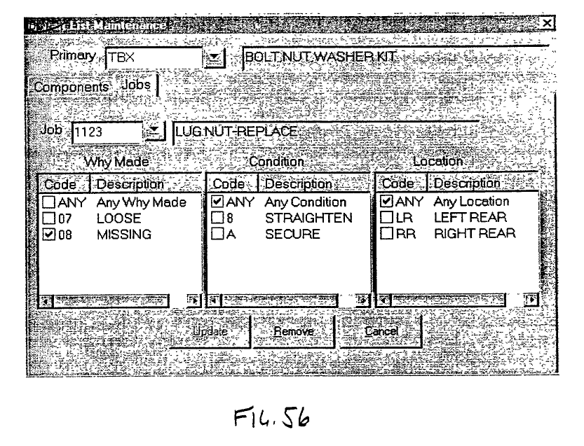

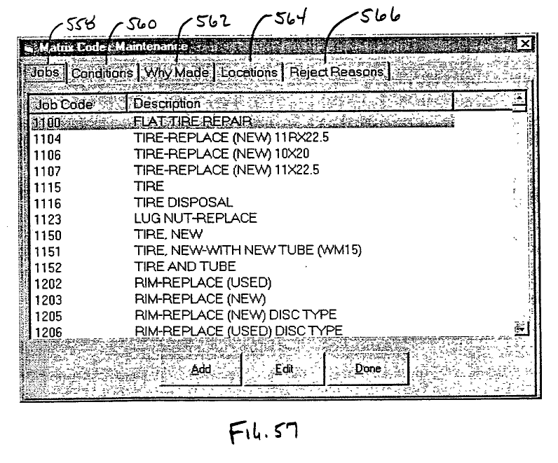

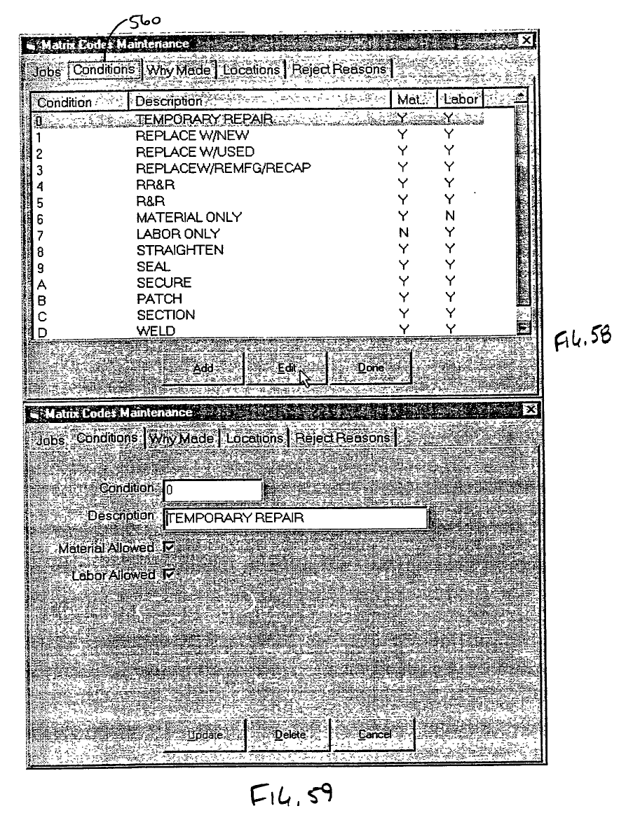

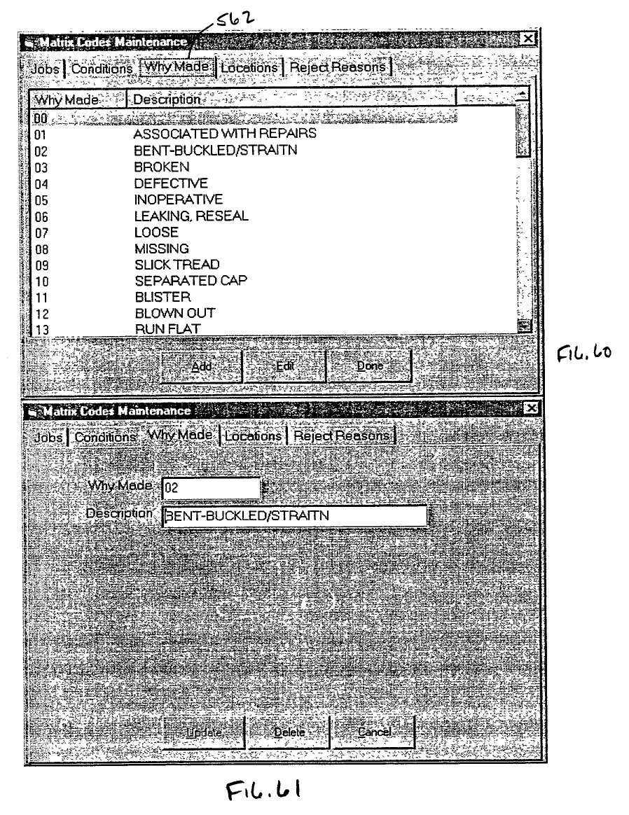

Referring again to FIGS. 29 and 34, the Matrix Codes screen 334 is accessed by clicking the Matrix Codes button 518, and the Matrix Codes screen 334 is displayed, as shown in FIGS. 57-65. The screen includes a number of tabs along the top, each of which can be clicked to access different screen options. The user can click the Jobs tab 558 and the screen shown in FIG. 57 will be displayed. This screen allows a specific job to be selected, and the job code and description can be modified or added to the system. The screen associated with the Conditions tab 560 is illustrated in FIG. 58. Each condition listed in the Conditions list when the Conditions tab 560 is clicked can be modified or added to the system by either highlighting the condition and clicking the Edit button, or clicking the Add button to add a new condition. In either event, the screen illustrated in FIG. 59 will be displayed, and modifications can be made to the description of the condition and certain default values. The screen associated with the Why Made tab 562 is illustrated in FIG. 60. Each description of why a repair was made listed in the Why Made list when the Why Made tab 562 is clicked can be modified or added to the system by either highlighting the Why Made entry and clicking the Edit button, or clicking the Add button to add a new Why Made entry. In either event, the screen illustrated in FIG. 61 will be displayed, and modifications can be made to the description of the Why Made entry. The screen associated with the Locations tab 564 is illustrated in FIG. 62. Each description of the location of a repair listed in the Location list when the Location tab 564 is clicked can be modified or added to the system by either highlighting the location and clicking the Edit button, or clicking the Add button to add a new location. In either event, the screen illustrated in FIG. 63 will be displayed, and modifications can be made to the description of the location. The screen associated with the Why Made tab 562 is illustrated in FIG. 60. Each description of why a repair was made listed in the Why Made list when the Why Made tab 562 is clicked can be modified or added to the system by either highlighting the Why Made entry and clicking the Edit button, or clicking the Add button to add a new Why Made entry. In either event, the screen illustrated in FIG. 61 will be displayed, and modifications can be made to the description of the Why Made entry. The screen associated with the Reject Reasons tab 566 is illustrated in FIG. 64. Each description of why a part was rejected listed in the Reject Reasons list when the Reject Reasons tab 566 is clicked can be modified or added to the system by either highlighting the reject reason and clicking the Edit button, or clicking the Add button to add a new reject reason. In either event, the screen illustrated in FIG. 65 will be displayed, and modifications can be made to the description of the reject reasons. The entry of information for each tab in the Matrix Codes data entry screens 334 updates the Matrix Database Supporting Tables 108.

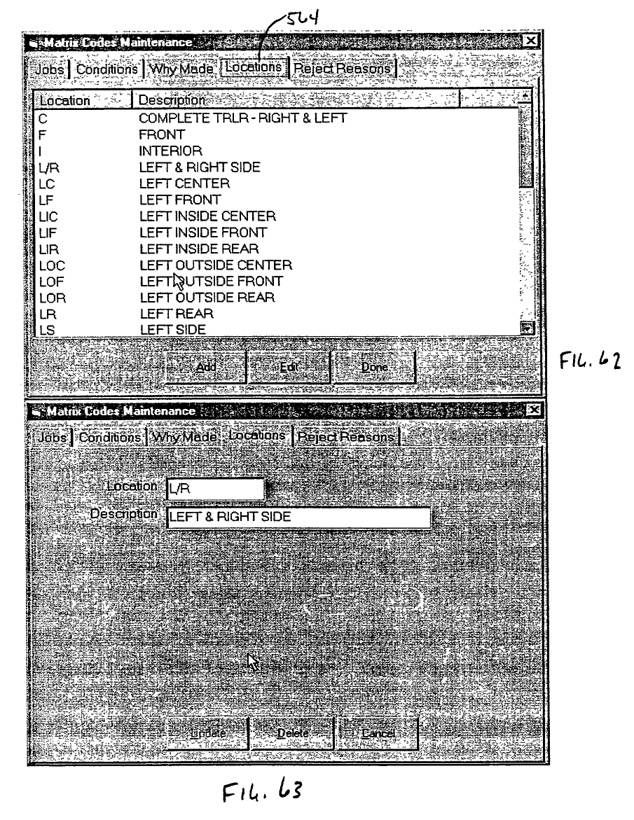

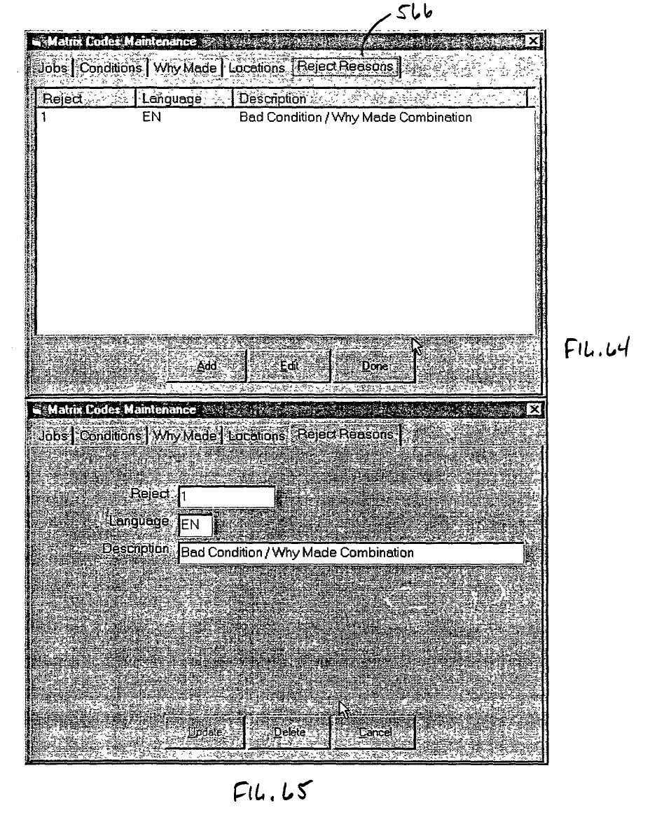

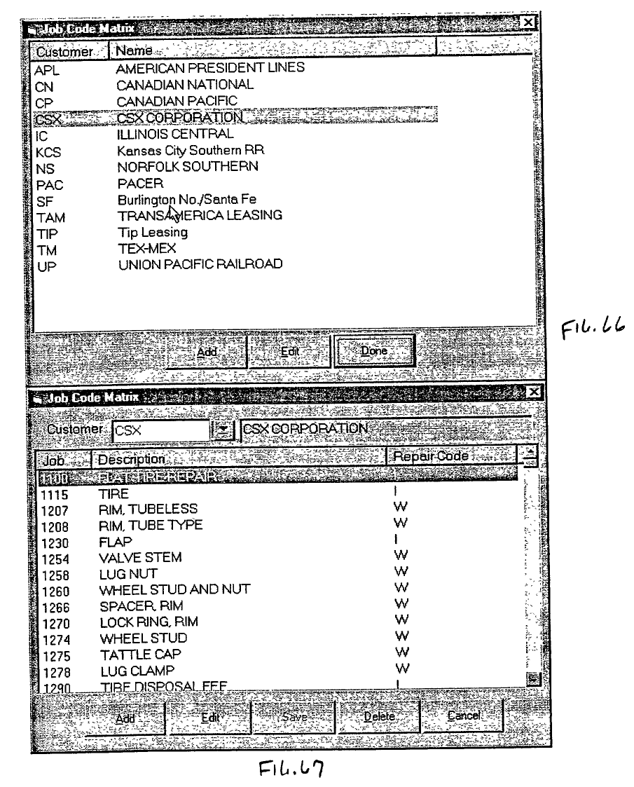

Referring again to FIGS. 29 and 34, the Job Matrix screen 336 is accessed by clicking the Job Matrix button 520, and the Job Matrix screen 336 is displayed, as shown in FIGS. 66-75. FIG. 66 shows the initial screen that displays a list of customers which can be selected to edit or add a Job Matrix for. After a customer is selected in FIG. 66, the screen illustrated in FIG. 67 is displayed. This includes a list of job descriptions for the selected customer. This screen allows a specific job to be selected, and the job code and description can be modified or added to the system. When a job description is selected from the screen in FIG. 67, the screen illustrated in FIG. 68 is displayed. This screen includes a number of tabs that may be selected for modification by the user, as described below.

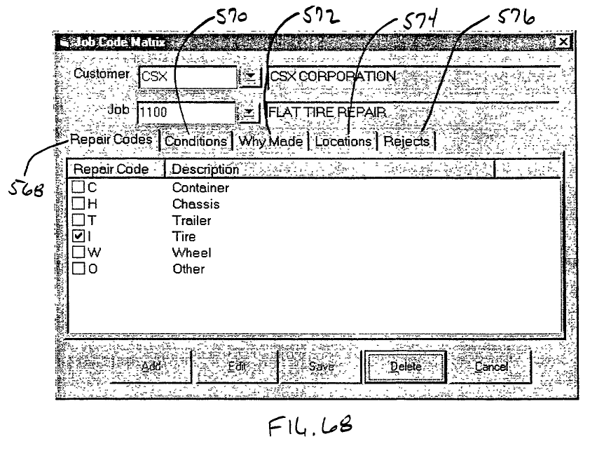

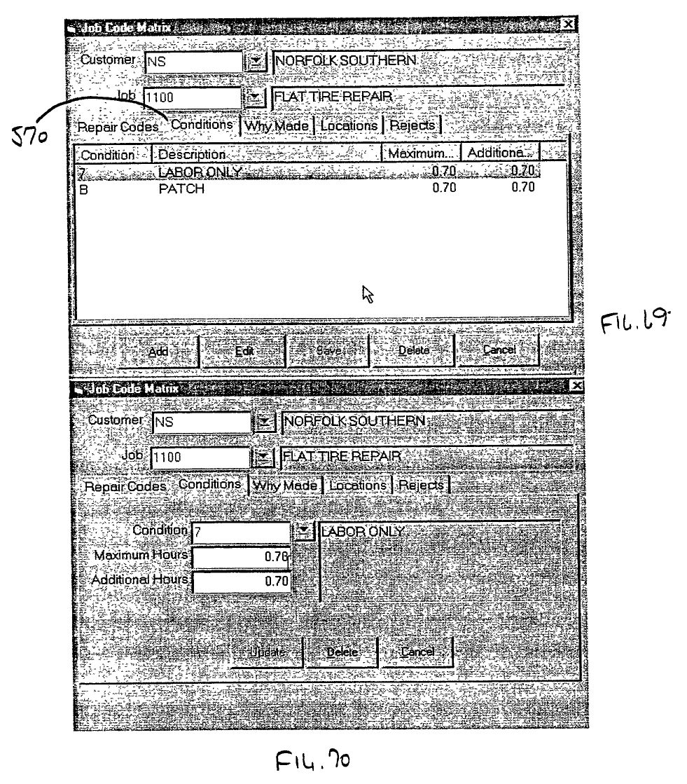

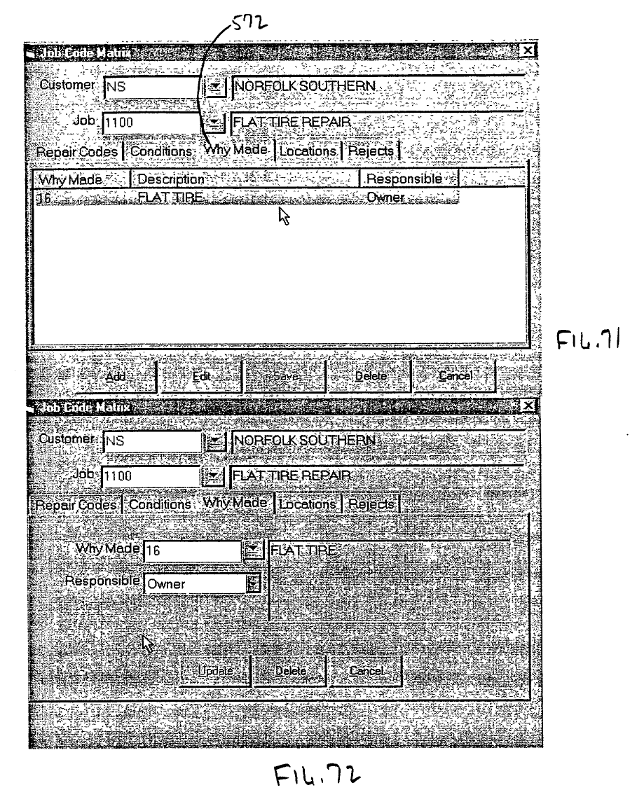

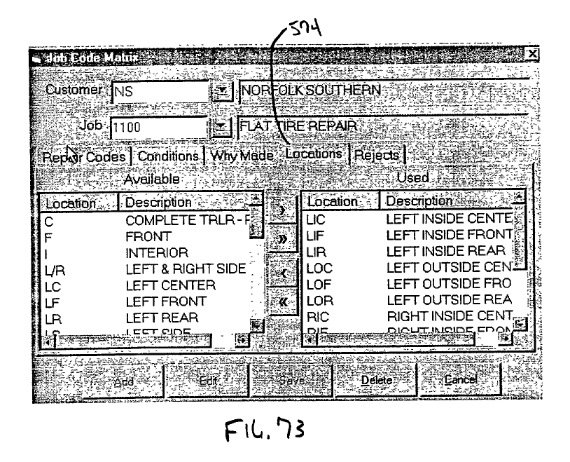

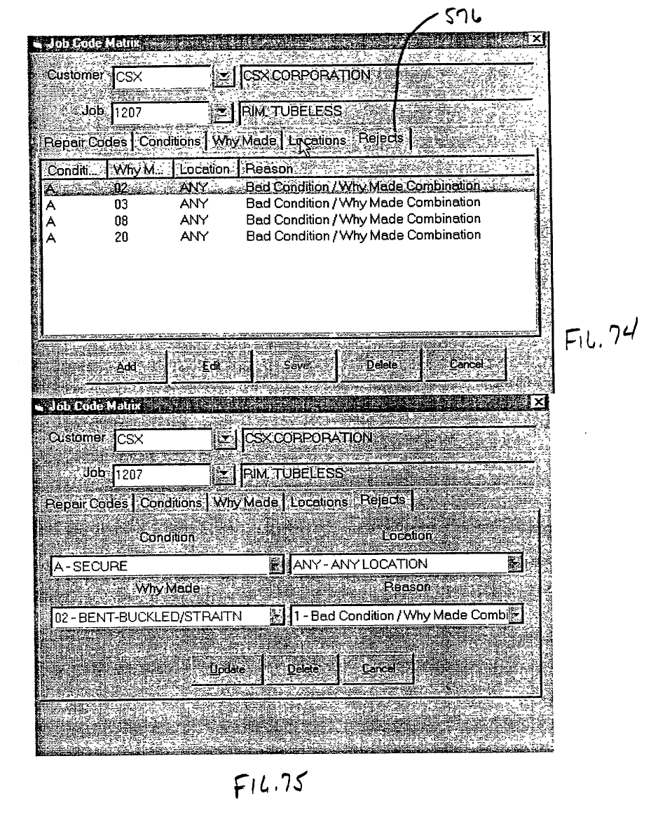

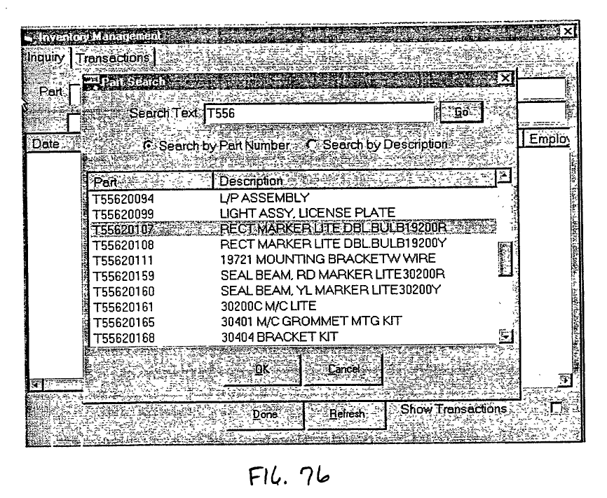

The screen associated with the Repair Codes tab 568 is illustrated in FIG. 68. Various repair codes can be selected to be associated with the Job Matrix screen, and this screen can be used for setting combinations of codes in the Matrix Database Supporting Tables 108 available to specific customers. The screen associated with the Conditions tab 570 is illustrated in FIG. 69. Each description of the condition of a repair listed in the conditions list when the Conditions tab 570 is clicked can be modified or added to the system by either highlighting the condition and clicking the Edit button, or clicking the Add button to add a new condition. In either event, the screen illustrated in FIG. 70 will be displayed, and modifications can be made to the description of the condition. The screen associated with the Why Made tab 572 is illustrated in FIG. 71. Each description of why a repair was made listed in the Why Made list when the Why Made tab 572 is clicked can be modified or added to the system by either highlighting the Why Made entry and clicking the Edit button, or clicking the Add button to add a new Why Made entry. In either event, the screen illustrated in FIG. 72 will be displayed, and modifications can be made to the description of the Why Made entry. The screen associated with the Locations tab 574 is illustrated in FIG. 73. Each description of the location of a repair available to the system is listed in the Available list and can be selected by highlighting the location and clicking the arrow to add the location to the Used location list. Similar, locations can be removed from the Used location list be clicking on the arrow pointing in the opposite direction. All locations in the Available list can either be added to, or removed from the Used list by clicking the appropriate double-arrow buttons. The screen associated with the Rejects tab 576 is illustrated in FIG. 74. Each description of why a part was rejected listed in the Rejects list when the Rejects tab 576 is clicked can be modified or added to the system by either highlighting the reject reason and clicking the Edit button, or clicking the Add button to add a new reject reason. In either event, the screen illustrated in FIG. 75 will be displayed, and modifications can be made to the description of the reject reasons. The entry of information for each tab in the Job Matrix data entry screens 336 updates the Matrix Database Supporting Tables 108.

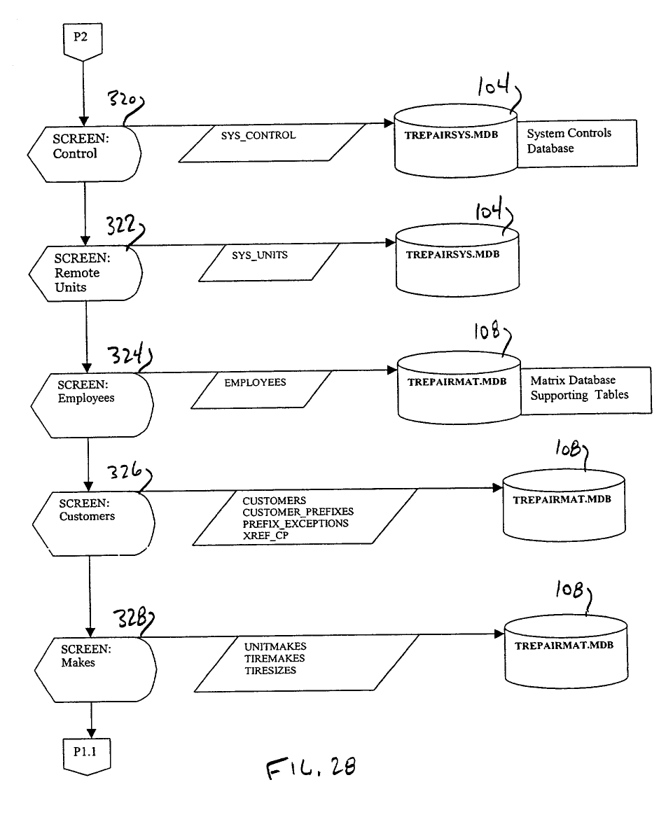

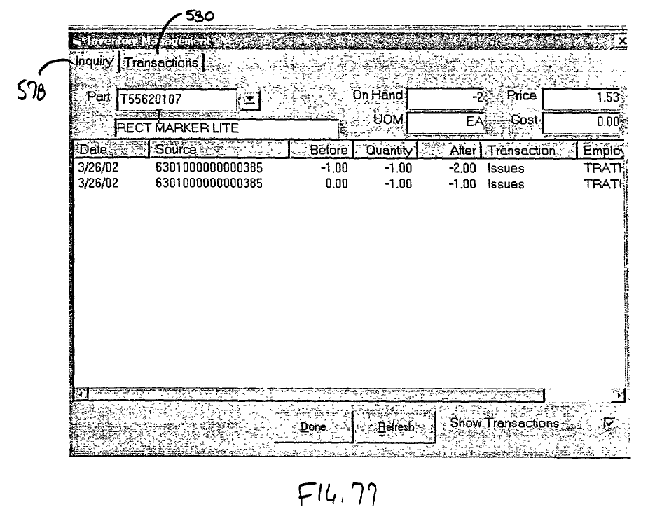

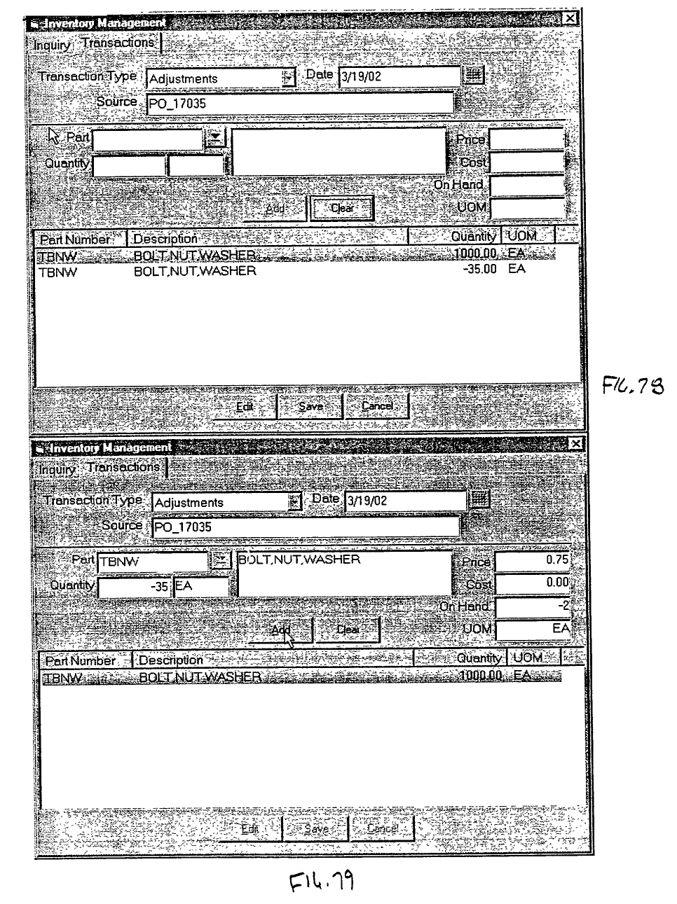

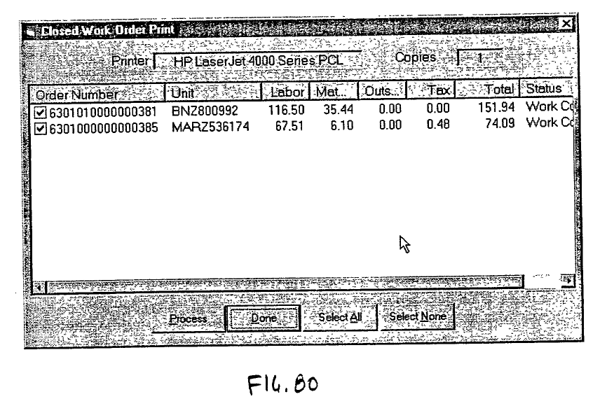

Referring again to FIG. 29, after the information has been input to the Job Matrix screen 336, the system continues to P1.1, as shown in FIG. 27, and then again proceeds to the Maintain Tables tab screen 306, illustrated in FIG. 34. From the Maintain Tables tab screen 306, the user can select options under Transactions 312, and the system moves to P4, which is shown in FIG. 30. The user can select the Inventory screen 338 by clicking on the Inventory button 522 shown on FIG. 34. This will display the Inventory screen 338, illustrated in FIGS. 76-79. The initial screen that will be displayed is illustrated in FIG. 76, which lists parts in inventory, and allows for searching of the parts. When parts are selected from the screen illustrated in FIG. 76, the Inventory screen is displayed as illustrated in FIG. 77. When the Inquiry tab 578 is clicked, information about the inventory of the selected part is displayed. When the Transactions tab 580 is clicked, the screens illustrated in FIGS. 78 and 79 are displayed, and the user is able to make adjustments to the quantity of parts recorded in inventory. In accessing the Inventory screen 338, information is received from the Matrix Database Supporting Tables 108 and is supplied to the Order Database Tables 114.

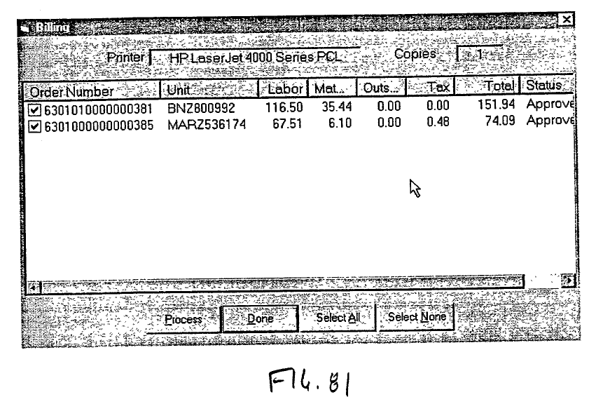

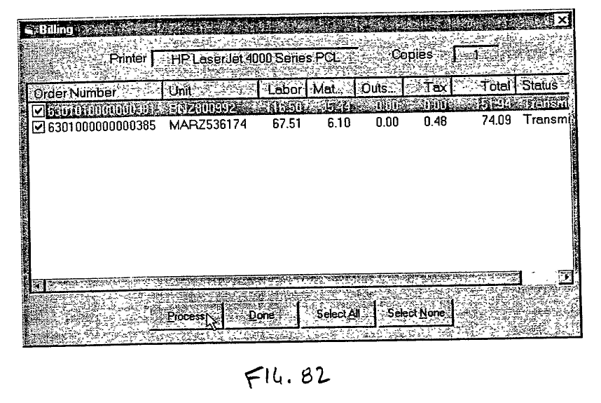

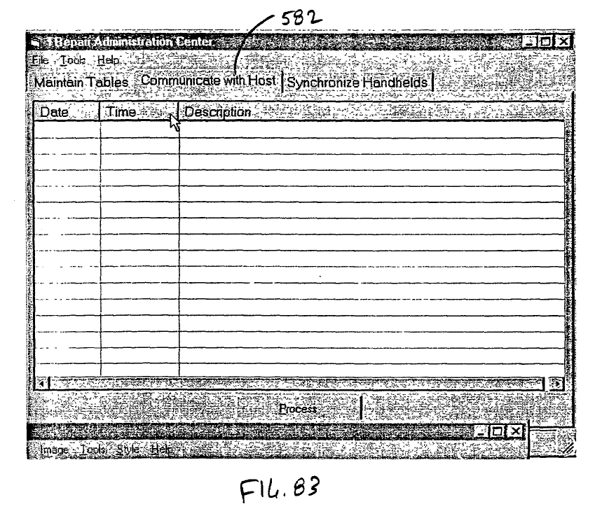

Referring again to FIGS. 30 and 34, the Order Print screen 340 is accessed by clicking the Order Print button 524, and the Order Print screen 340 is displayed, as shown in FIG. 80. In this screen, specific orders can be selected for printing. Information is supplied to Order Database Tables 114, and a work order form is printed at 346. The Billing screen 342 is accessed by clicking the Billing button 526, and the Billing screen 342 is displayed, as shown in FIG. 81. This screen allows the selection of an order that has an approved status for generation of an invoice form. Information is supplied to Order Database Tables 114, and a invoice form is generated at 348. In addition, the status of the order is changed from approved to invoiced, and this is communicated to Order Database Tables 114. Finally, the Billing Reprint screen 344 is accessed by clicking the Billing Reprint button 528, and the Billing Reprint screen 344 is displayed, as shown in FIG. 82. This screen is used to reprint invoices that have previously been created. Information is supplied to Order Database Tables 114, and a invoice form is generated at 348.

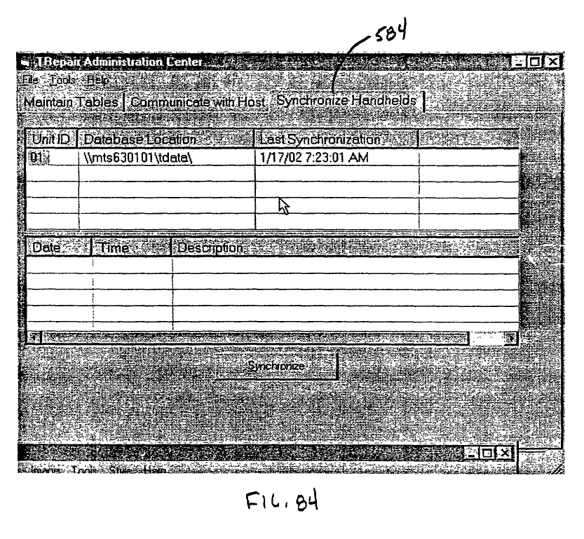

Referring again to FIG. 30, after the Billing Reprint screen 344 has been accessed, the system continues to P1.1, as shown in FIG. 27, and then again proceeds to the Maintain Tables tab screen 306, illustrated in FIG. 34. The Communicate with Host tab 582 can be clicked to access the Communicate with Host screen 314, as illustrated by FIG. 83. This allows the system to transfer data between the server computers 30 and central computer 10 via file transfer protocol. Table data for Makes, Parts, and Job Matrix are imported from the central computer 10 and approved orders and customer data are exported to the central computer 10. When the Communicate with Host tab 582 is clicked, the system proceeds to P5, illustrated on FIG. 31. A connection is established to ftp server at step 352, and the transfer of information is processed at step 354. Information is exported from the server computer 30 at step 356 from the Order Database Tables 114. Then information is imported to the server computer 30 into the Matrix Database Supporting Tables 108 at step 358.

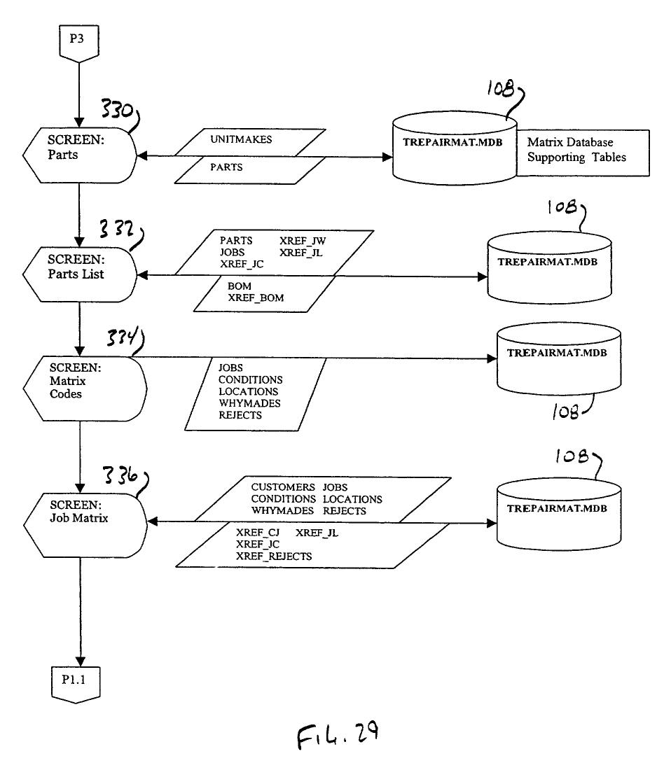

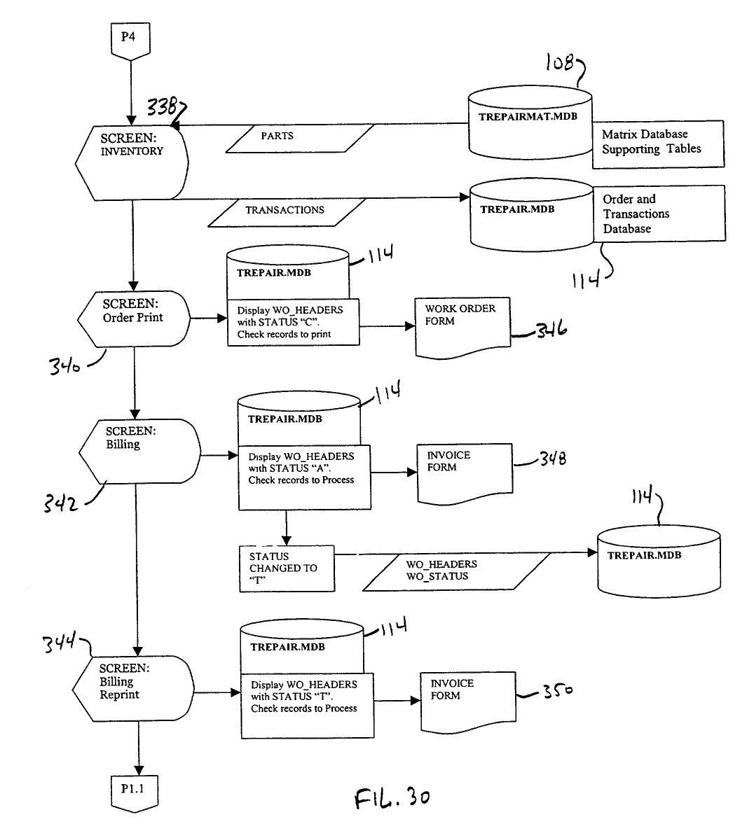

After the import step 358, the system proceeds to P1.2, as shown in FIG. 27, and then again proceeds to the Communicate with Host tab screen 314, illustrated in FIG. 83. At this screen, the Synchronize Handhelds screen 316 can be accessed by clicking the Synchronize Handhelds tab 584 to display the screen illustrated in FIG. 84. When the Synchronize Handhelds tab 584 is clicked, the system proceeds to P6, illustrated in FIG. 32. First, a connection is established between the server computer 30 and the related mobile units at step 358. The connections between these various units are synchronized. Next, information is imported from the mobile units to the related server computer 30 at step 362. First, the System Controls Database 104 is accessed to determine the mobile units that must be polled. It is determined for each mobile unit whether there is a network connection at step 364. If there is a network connection, then the system transmits information to the Order Database Tables 114 and the Matrix Database Supporting Tables 108. Then, the system determines whether there is another mobile unit to be accessed at step 366. If there is, the system returns to step 364 to determine whether the next mobile unit is connected to the network for importation of data. If step 364 discovers that the mobile unit is not connected to the network, then the system determines whether there is another mobile unit to be accessed at step 366. If there is, the system returns to step 364 to determine whether the next mobile unit is connected to the network for importation of data. If there is not another mobile unit to be accessed, the system proceeds to P7, illustrated in FIG. 33.

Referring now to FIG. 33, the server computer 30 exports data to the mobile units at step 366. Information about each mobile unit is received from System Controls Database 104, and the system determines whether there is an additional unit to be exported to at step 368. If there is, the system determines whether the mobile unit has a network connection at step 370. If it does, information is exported to the unit from the Order Database Tables 114. If there is not network connection at step 370, the system determines whether there is another mobile unit to be exported to at step 368. After information is exported to the unit, the system determines whether there is another mobile unit to be exported to at step 368. If there is, the process repeats, and if there is not, the system receives information about each mobile unit from System Controls Database 104, and the system determines whether there is an additional unit to be exported to at step 372. If there is, the system determines whether the mobile unit has a network connection at step 374. If it does, the complete database information is exported to the unit from the System Controls Database 104 and the Matrix Database Supporting Tables 108. If there is not network connection at step 374, the system determines whether there is another mobile unit to be exported to at step 372. After information is exported to the unit, the system determines whether there is another mobile unit to be exported to at step 372. If there is, the process repeats, and if there is not, the system proceeds to P1.3. P1.3 returns the system to the Synchronize Handhelds screen at 316 in FIG. 27, and the system can then proceed to the Menu Options at step 318, where the user can exit the system.

It is to be understood that a wide range of changes and modifications to the embodiments described above will be apparent to those skilled in the art, and these changes and modifications are contemplated herein. It is, therefore, intended that the foregoing detailed description be regarded as illustrative rather than limiting, and that it be understood that it is the following claims, including all equivalents, that are intended to define the spirit and scope of the invention.

We claim:

1. An electronic system for monitoring and coordinating equipment repair comprising:
a central computer;
one or more server computers that communicate with the central computer; and
one or more mobile units that each communicate with at least one server computer, wherein;
each server computer receives information from the central computer regarding repair information;
each mobile unit provides information to a technician regarding an equipment repair project; and
the technician inputs information about the equipment maintenance or repair project to the mobile unit.

2. The system as claimed in claim 1, wherein the information provided to the technician regarding the equipment repair project includes customer data, equipment information, and repair instructions.

3. The system as claimed in claim 2, wherein the information input by the technician regarding the equipment repair project includes material used, labor performed, time worked.

4. The system as described in claim 3, wherein the technician inputs information via a series of numerical codes.

5. The system as claimed in claim 1, wherein each mobile unit comprises a handheld, pen-based computer incorporating a touch screen.

6. The system as claimed in claim 5, wherein each mobile unit includes a touch-screen keypad.

7. The system as claimed in claim 1, wherein each mobile unit communicates with the server computer through one or more of: a local area network; a global computer network; a radio frequency link; and a cellular technology link.

8. The system as claimed in claim 1, wherein the information provided to the technician by the mobile unit is received by the mobile unit from the server computer and the information input by the technician to the mobile unit is transmitted to the server computer.

9. The system as claimed in claim 8, wherein the central computer gathers information from the server computers that has been received from multiple mobile units and stores the information for use in one or more of: customer billing; inventory control; cost reporting; accounts payable; payroll; and labor distribution.

10. An electronic system for monitoring and coordinating equipment repair comprising:
a central computer;
one or more server computers in communication with the central computer; and
multiple mobile units that communicate with at least one server computer, wherein;
each mobile unit provides information to a technician regarding an equipment repair project, including customer data, type of equipment, and repair instructions; and
the technician inputs information about the equipment repair project to the mobile unit.

11. The system as claimed in claim 10, wherein the information input by the technician regarding the equipment repair project includes material used, labor performed, time worked.

12. The system as described in claim 11, wherein the technician inputs information via a series of numerical codes.

13. The system as claimed in claim 11, wherein each mobile unit comprises a handheld, pen-based computer incorporating a touch screen.

14. The system as claimed in claim 13, wherein each mobile unit includes a touch-screen keypad.

15. The system as claimed in claim 10, wherein each mobile unit communicates with the server computer through one or more of: a local area network; a global computer network; a radio frequency link; and a cellular technology link.

16. The system as claimed in claim 15, wherein the information provided to the technician by the mobile unit is received by the mobile unit from the server computer, which is received from the central computer and the information input by the technician to the mobile unit is transmitted to the server computer and then to the central computer.

17. The system as claimed in claim 16, wherein the central computer gathers information received from multiple server computers and stores the information for use in one or more of: customer billing; inventory control; cost reporting; accounts payable; payroll; and labor distribution.
